(19) United States
(12) Patent Application Publication
(10) Pub. No.: US 2024/0185048 A1
(43) Pub. Date: Jun. 6, 2024

(54) SYSTEMS AND METHODS FOR PARALLELIZING OPERATOR GRAPHS USING BOTTLENECK STRUCTURES

(71) Applicant: QUALCOMM Incorporated, San Diego, CA (US)

(72) Inventors: Naila Carmen SEBASTIAN, Pamplona (ES); Lucia Regina O'TOOLE, Somerville, MA (US); Jordi ROS GIRALT, Vilafranca del Penedes (ES)

(21) Appl. No.: 18/503,005

(22) Filed: Nov. 6, 2023

Related U.S. Application Data
(60) Provisional application No. 63/430,278, filed on Dec. 5, 2022.

(51) Int. Cl. G06N 3/063

(52) U.S. Cl. CPC G06N 3/063

(57) ABSTRACT

A processor-implemented method includes receiving a parallelization solution for executing an operating graph with a computing device topology. The method also includes computing a bottleneck structure corresponding to the computing device topology and the parallelization solution. The method further includes computing a cost value of the parallelization solution based on the bottleneck structure.

### CROSS-REFERENCE TO RELATED APPLICATION

The present application claims the benefit of U.S. Provisional Patent Application No. 63/430,278, filed on Dec. 5, 2022, and titled “SYSTEMS AND METHODS FOR PARALLELIZING OPERATOR GRAPHS USING BOTTLENECK STRUCTURES,” the disclosure of which is expressly incorporated by reference in its entirety.

### FIELD OF THE DISCLOSURE

Aspects of the present disclosure generally relate to systems and methods for parallelizing operator graphs (e.g., neural networks) using bottleneck structures.

### BACKGROUND

A neural network is a specific type of operator graph. Operator graphs, such as deep neural network (DNN) structures have been increasing in size. The increase in size may improve accuracy of the neural networks and/or enable the neural networks to address a growing number of tasks. Larger neural networks operate more efficiently on larger processing systems with larger amounts of memory. On the other hand, demand has increased for the ability to efficiently run neural networks in small hardware devices, such as mobile phones, automobiles, or internet-of-things (IOT) devices.

Parallelization is a technique for processing data in parallel. For example, a neural network may be split into multiple components, each component assigned to different hardware resources for independent processing. With parallelization, solutions may be achieved more quickly than with traditional serial processing or larger neural networks may be operated. Parallelization is also a solution for running larger neural networks on smaller hardware devices.

It would be helpful to find efficient parallelization strategies for both training the neural networks and performing inference with the neural networks. Randomized algorithms are currently employed to search across the very large search space of possible DNN parallelization strategies. A more focused approach would be desirable.

### SUMMARY

In aspects of the present disclosure, a processor-implemented method includes receiving a parallelization solution for executing an operating graph with a computing device topology. The method also includes computing a bottleneck structure corresponding to the computing device topology and the parallelization solution. The method further includes computing a cost value of the parallelization solution based on the bottleneck structure.

In other aspects of the present disclosure, a processor-implemented method includes receiving an operator graph at a first processing block. The method also includes receiving a computing device topology at the first processing block. The method further includes executing an optimization process at the first processing block based on the computing device topology and the operating graph to determine a parallelization solution for executing the operating graph with the computing device topology. The method still further includes receiving the parallelization solution at a second processing block. The method also includes computing, at the second processing block, a bottleneck structure. The method still further includes computing, at the second processing block, a cost value of the parallelization solution based on the bottleneck structure. The method still further includes transmitting the cost value from the second processing block to the first processing block. The method also includes executing the optimization process at the first processing block based on the computing device topology, the operating graph, the cost value, to determine a neighbor parallelization solution.

Other aspects of the present disclosure are directed to an apparatus. The apparatus has at least one memory and one or more processors coupled to the at least one memory. The processor(s) is configured to receive an operator graph at a first processing block. The processor(s) is also configured to receive a computing device topology at the first processing block. The processor(s) is further configured to execute an optimization process at the first processing block based on the computing device topology and the operating graph to determine a parallelization solution for executing the operating graph with the computing device topology. The processor(s) is also configured to receive the parallelization solution at a second processing block, and to compute, at the second processing block, a bottleneck structure. The processor(s) is also configured to compute, at the second processing block, a cost value of the parallelization solution based on the bottleneck structure, and to transmit the cost value from the second processing block to the first processing block. The processor(s) is also configured to execute the optimization process at the first processing block based on the computing device topology, the operating graph, the cost value, to determine a neighbor parallelization solution.

Other aspects of the present disclosure are directed to an apparatus. The apparatus has at least one memory and one or more processors coupled to the at least one memory. The processor(s) is configured to receive a parallelization solution for executing an operating graph with a computing device topology. The processor(s) is also configured to compute a bottleneck structure corresponding to the computing device topology and the parallelization solution. The processor(s) is further configured to compute a cost value of the parallelization solution based on the bottleneck structure.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

The present disclosure will become more apparent in view of the attached drawings and accompanying detailed description. The aspects depicted therein are provided by way of example, not by way of limitation, wherein like reference numerals/labels generally refer to the same or similar elements. In different drawings, the same or similar elements may be referenced using different reference numerals/labels, however. The drawings are not necessarily to scale, emphasis instead being placed upon illustrating aspects of the invention. In the drawings:

FIG. 1 illustrates an example implementation of a neural network using a system-on-a-chip (SOC), including a general-purpose processor in accordance with certain aspects of the present disclosure.

FIG. 2A is a block diagram illustrating core building blocks for parallelizing operator graphs with bottleneck structures, in accordance with aspects of the present disclosure.

FIG. 2B is a diagram illustrating an optimized neural network parallelization graph and a sub-optimal neural network parallelization graph, in accordance with aspects of the present disclosure.

FIGS. 3A and 3B show different aspects of a procedure to construct a bottleneck structure used in analysis and manipulation of a network.

FIG. 3C shows different aspects of a procedure to compute link and flow gradients using a gradient graph, according to various aspects.

FIGS. 4A and 4B illustrate analysis of bottleneck links and bottleneck flows, according to various aspects, according to various aspects.

FIGS. 4C and 4D illustrate computation of gradients for the links and flows depicted in FIGS. 4A and 4B, according to various aspects.

FIG. 5A presents a procedure to determine leaps and folds associated with flows and links, according to various aspects.

FIG. 5B presents a procedure to optimize a flow using flow and link gradients, according to various aspects.

FIG. 6 presents a procedure to compute a maximum achievable flow rate for a flow in a network, using a gradient graph of the network, according to various aspects.

FIG. 7 depicts one topology of an example network.

FIGS. 8A-8C show a sequence of gradient graphs and corresponding bottleneck structures generated using various aspects of the procedure depicted in FIG. 6.

FIGS. 9A shows the acceleration of the rate of a flow using two different techniques, one of which employs an aspect of the procedure shown in FIG. 6.

FIGS. 9B shows the acceleration of the rate of another flow using two different techniques, one of which employs an aspect of the procedure shown in FIG. 6.

FIG. 9C shows a comparison of experimental vs theoretical flow rates achieved for several flows.

FIG. 10 depicts an example fat-tree network topology.

FIGS. 11A-11C depict different bottleneck structures resulting from allotting, according to different aspects, different link capacities of certain links of the network of FIG. 9.

FIGS. 12A-12C illustrate the respective performance of network flows for the three bottleneck structures shown in FIGS. 11A-11C, using the bottleneck bandwidth and round-trip propagation time (BBR) congestion control algorithm, according to some aspects.

FIG. 13 depicts another topology of an example network.

FIG. 14A shows a bottleneck structure of the network shown in FIG. 13.

FIGS. 14B and 14C show bottleneck structures of the network upon adding a flow to the network, according to different aspects.

FIGS. 15 and 16 illustrate processes for parallelizing an operator graph, in accordance with various aspects of the present disclosure.

### DETAILED DESCRIPTION

A neural network is a particular type of operator graph. Although the following description is primarily with respect to neural networks, the disclosure is not so limited. Any type of operator graph is contemplated.

With growing deep neural network (DNN) structures and the need to efficiently run the larger structures in small hardware devices, such as mobile phones, automobiles, or internet-of-things (IOT) devices, it is becoming increasingly important to find efficient parallelization strategies for both training and inference. New algorithms in this space, including FlexFlow (Zhihao Jia et al, 2018), TopoOpt (Weiyang Wang et al., 2022) and Unity (Zhihao Jia et al., 2022), suggest a randomized algorithm to search amongst the large search space of possible DNN parallelization strategies.

Bottleneck structures are computational graphs that characterize the state of a communication network allowing human operators and machines to quickly compute network derivatives. These derivatives are building blocks that enable the optimization of the system in a wide variety of problems, including routing, flow scheduling, task scheduling, neural network parallelization, capacity planning, system design, and resilience analysis, among many others. The theory of a bottleneck structure and its processes will be referred to as GradientGraph technology throughout this specification.

A parallelization strategy maps a neural network to a distributed computing system including multiple processing elements. Each processing element is assigned tasks to execute. The output of one task may be an input to another task. Aspects of the present disclosure parallelize the execution of a neural network (for both training and inference) on a multi-graphics processing unit (GPU)/multi-central processing unit (CPU) computing system. According to aspects of the present disclosure, a technique that uses GradientGraph as an artificial intelligence (AI) compiler tool may improve the results of deep neural network (DNN) parallelization algorithms. The improvements are seen as (1) improving the precision of a topology simulation stage and (2) leveraging gradient information provided by the bottleneck structure to make better than randomized iterative decisions. The techniques of the present disclosure reduce training time and inference time of a parallelizable neural network. These improvements lead to higher power efficiency.

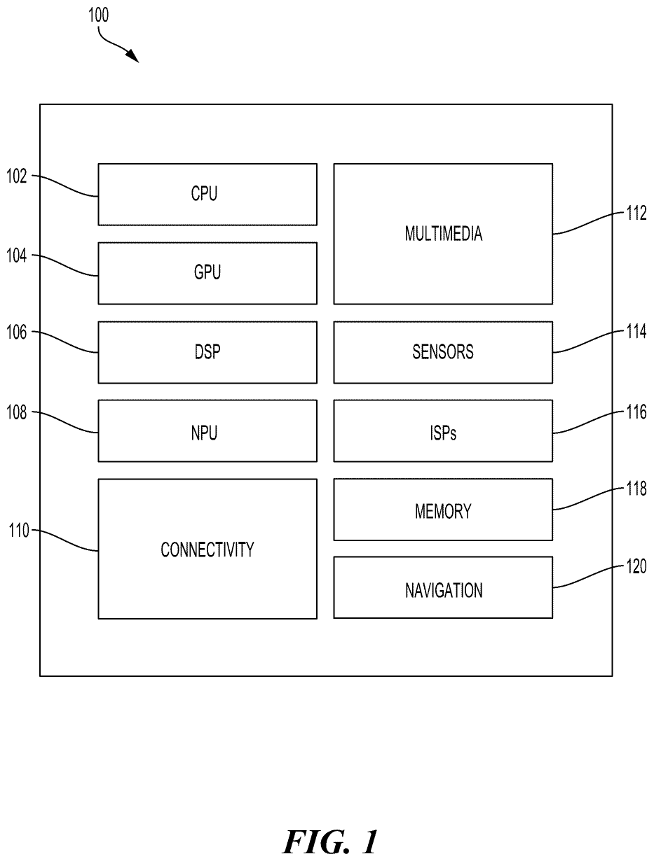

FIG. 1 illustrates an example implementation of a system-on-a-chip (SOC) 100, which may include a central processing unit (CPU) 102 or a multi-core CPU configured for parallelizing an operator graph using bottleneck structures. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive an operator graph at a first processing block. The general-purpose processor 102 may also include code to receive a computing device topology at the first processing block. The general-purpose processor 102 may further include code to execute an optimization process at the first processing block based on the computing device topology and the operating graph to determine a parallelization solution for executing the operating graph with the computing device topology. The general-purpose processor 102 may also include code to receive the parallelization solution at a second processing block. The general-purpose processor 102 may further include code to compute, at the second processing block, a bottleneck structure. The general-purpose processor 102 may also include code to compute, at the second processing block, a cost value of the parallelization solution based on the bottleneck structure. The general-purpose processor 102 may further include code to transmit the cost value from the second processing block to the first processing block. The general-purpose processor 102 may still further include code to execute the optimization process at the first processing block based on the computing device topology, the operating graph, the cost value, to determine a neighbor parallelization solution.

In other aspects of the present disclosure, the instructions loaded into the general-purpose processor 102 may include code to receive a parallelization solution for executing an operating graph with a computing device topology. The general-purpose processor 102 may also include code to compute a bottleneck structure corresponding to the computing device topology and the parallelization solution. The general-purpose processor 102 may further include code to compute a cost value of the parallelization solution based on the bottleneck structure.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

A parallelization strategy maps an operator graph, such as a neural network, to a distributed computing system including multiple processing elements. Examples of processing elements include the CPU 102, GPU 104, DSP 106, and NPU 108 seen in FIG. 1. Each processing element is assigned tasks to execute. The output of one task may be an input to another task. Aspects of the present disclosure parallelize the execution of a neural network (for both training and inference) on a multi-GPU/multi-CPU computing system.

Presently, metaheuristic techniques, such as Markov Chain Monte Carlo (MCMC), are being used. However, due to the computational complexity of the search process, current solutions make very simplistic assumptions of the interconnect of the neural network. In particular, current solutions assume the interconnect is fully-meshed connected to simplify processing.

Aspects of the present disclosure employ bottleneck structures (the technique is referred to as GradientGraph in this specification) to efficiently and accurately model the device topology. Employing bottleneck structures allows the metaheuristic process to more accurately estimate the cost function being minimized, leading to improved solutions. In other words, the parallelization strategies of the neural network are improved, thereby reducing training and inference time. In addition, the GradientGraph technique computes gradients and helps the metaheuristic make biased randomized configuration selections, leading to an improved stochastic gradient descent process.

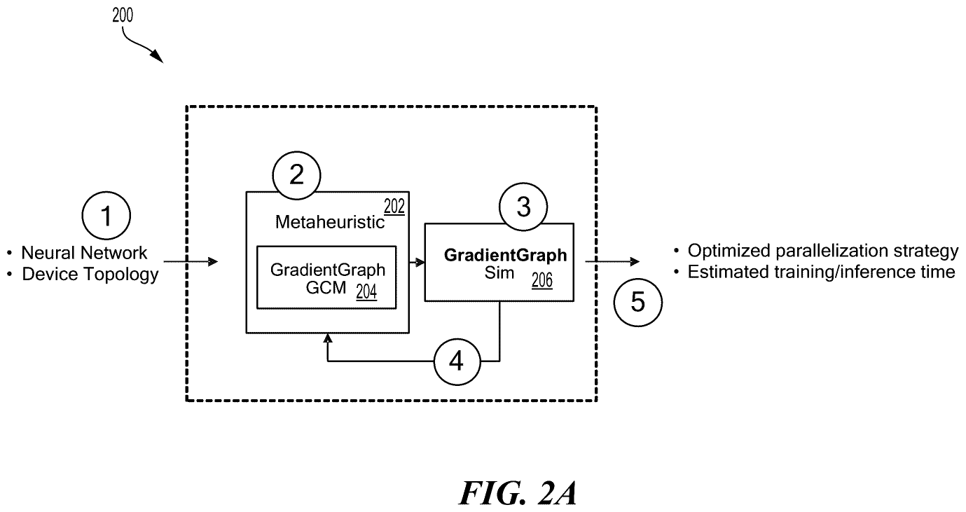

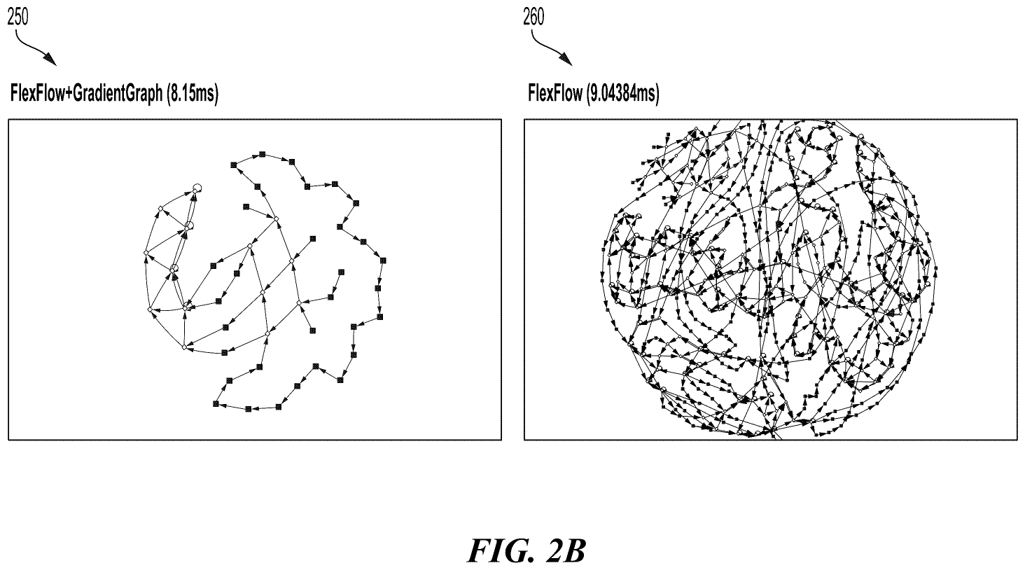

FIG. 2A is a block diagram illustrating core building blocks for parallelizing operator graphs with bottleneck structures, in accordance with aspects of the present disclosure. As seen in FIG. 2A, a parallelization system 200 receives an input. The input may include a device topology representing how compute nodes are interconnected with each other. The input may also include an operator graph, such as a neural network, to be mapped onto the device topology. The example of FIG. 2A illustrates an example of parallelization of a neural network.

Output from the parallelization system 200 may include an improved or even optimized parallelization strategy for how the neural network (NN) is to be mapped onto the topology device. The output also includes an estimated training or inference time, depending on whether the parallelization is for a training or inference process.

According to aspects of the present disclosure, at step 1, inputs are fed into a first stage metaheuristic block 202 that implements a metaheuristic. Examples of metaheuristics include Markov Chain Monte Carlo techniques and simulated annealing techniques. The present disclosure is not constrained to these techniques, as other heuristics or optimization techniques can also be used, such as dynamic programming, branch and bound, etc.

At step 2, the metaheuristic block 202 proposes a candidate solution. The metaheuristic block 202 initially generates a random parallelization strategy to be simulated by a simulator block 206. For future iterations, the metaheuristic block 202 leverages gradient information provided by a GradientGraph-GCM (gradient computation module) block 204 to bias the probability of selecting a next candidate solution that has a lower cost. The next candidate solution is slightly changed from the current solution. The GradientGraph-GCM block 204 determines which nodes of the network are likely good candidates for change, based on calculated gradients. That is, a positive gradient indicates a particular node is a good candidate for change, whereas a negative gradient suggests another node should be considered. If the next candidate solution has a better processing time (discussed next with respect to step 3), the metaheuristic block 202 may continue in the direction of that candidate solution. Otherwise, the metaheuristic block 202 selects another direction. Some amount of randomness may be introduced to overcome any local minima. The GradientGraph-GCM block 204 biases the randomness to obtain a better structure.

At step 3, the proposed solution is fed into a GradientGraph digital twin (DT) simulator block 206. The GradientGraph DT simulator block 206 leverages the analytical power of bottleneck structures to efficiently compute the cost value of such a solution. That is, a training or inference time may be calculated for the proposed solution. The GradientGraph DT simulator block 206 calculates the cost based on actual interconnect structures, as opposed to always assuming a fully connected mesh interconnect. That is, the GradientGraph DT simulator block 206 analyzes flows and processes how different permutations traverse the network. In contrast, conventional systems assume a fully connected mesh interconnect structure.

At step 4, the cost of the solution is fed back into the metaheuristic block 202, which uses the cost to compute another candidate solution. Then, the process flows to step 3 for another iteration of the procedure. Steps 3 and 4 iterate until a satisfactory solution is identified, at which point the procedure terminates (step 5) and the GradientGraph DT simulator block 206 outputs the parallelization strategy. A predetermined number of iterations may control when the process ends, or a threshold level of performance being achieved may control when the process ends.

By incorporating the GradientGraph GCM block 204 and the GradientGraph DT simulator block 206 in the above procedure, advantages are realized. For example, the quality of the candidate solutions is improved. To compute the cost value of a candidate solution, existing approaches are based on a simplified simulator that assumes the topology device corresponds to a full mesh. This assumption keeps the computation of the cost value simple, but at the same time represents an oversimplification of the system. Oversimplification leads to inaccurate values of the cost function and therefore to suboptimal solutions. With the GradientGraph DT simulator block 206 as the simulator, the topology may be accurately represented without assuming a full mesh. The accurate representation leads to a more accurate estimate of the cost value and, as a result, to solutions of higher quality (e.g., lower cost).

Another advantage is improved computational speed. The GradientGraph technique uses delta calculations to avoid calculating from scratch the gradients of the network. At each step of the metaheuristic process, a neighbor of the current solution is visited. Therefore, many candidate solutions may share most of the flows of the current solution. Utilizing calculations from the previous step, therefore, brings an increase in computing performance compared to performing the calculations from scratch at each step.

Another advantage is improved search paths within the feasible set. The present disclosure introduces a new procedure within the metaheuristic block 202 that biases the probability of moving into a new solution candidate based on the computation of gradient (e.g., derivatives) by using the bottleneck structure of the device topology. Such gradients can be computed quickly using the GradientGraph technique by leveraging bottleneck structure theory. This gradient computation helps drive the metaheuristic towards exploring search paths that are more likely to reach optimality, reducing the time to converge to a close-to-optimal solution.

The techniques of the present disclosure have two broad classes of use cases: reducing the training time of a neural network, and reducing inference time of a neural network. The neural network may be deployable in a variety of topology devices. For example, the neural network may be deployed on a processor, such as a multicore processor, a multi-processor platform, a multi-GPU edge cloud, a GPU cluster, or even a large-scale data center.

Referring back to FIG. 2A, the gradients computed from the bottleneck structure in the GradientGraph GCM block 204 help the metaheuristic block 202 take better-than-random directions, improving the convergence rate. Use of the GradientGraph as a digital twin in the GradientGraph DT simulator block 206 enables accurate and fast computing of the cost function. In some aspects, the GradientGraph GCM block 204 does not independently model the hardware. Rather, the GradientGraph GCM block 204 uses the model generated by the GradientGraph DT simulator block 206, thereby saving the energy needed to calculate the model on its own.

FIG. 2B is a diagram illustrating an optimized neural network parallelization graph and a sub-optimal neural network parallelization graph, in accordance with aspects of the present disclosure. In the example of FIG. 2B, an optimized neural network parallelization graph 250 and a sub-optimal neural network parallelization graph 260 are based on an input “Native-Split” neural network with a Dragonfly, 9, 3 topology. Processing the input with a prior art ‘FlexFlow’ technique results in the sub-optimal neural network parallelization graph 260. The processing takes 9.04 milliseconds. Processing the input by applying the techniques of the present disclosure results in the optimized neural network parallelization graph 250. The processing time is reduced to 8.15 milliseconds.

A detailed discussion of the GradientGraph technique is now provided. Bottleneck links in congestion-controlled networks do not operate as independent resources. For instance, the Mathis equation does not take into account the system-wide properties of a network, including its topology, the routing and the interactions between flows. In reality, bottleneck links generally operate according to a bottleneck structure described herein that can reveal the interactions of bottleneck links, and the system-wide ripple effects caused by perturbations in the network. Techniques using the bottleneck structure, such as the GradientGraph method described below, can address a gap in the analysis performed by the conventinal techniques, and can provide an alternative methodology to estimate network flow throughput.

A technique for expressing bottleneck structures takes into account the system-wide properties of a network, including its topology, the routing and the interactions between flows, and can numerically estimate flow throughput.

The bottleneck structure of a network can be represented qualitatively, via a bottleneck precedence graph (BPG), a structure that organizes the relationships among links. Techniques disclosed herein feature an enhanced analysis of a bottleneck structure that takes into account the relationships among flows and links, not just links, providing a more comprehensive view of the network or a system modeled as a network. As such, aspects of this technique may provide a framework to quantify the interactions among flows and links, resulting in a new class of algorithms to optimize network performance.

### 1 Introduction

Research on the problem of congestion control for data networks is generally based on the principle that the performance of a flow is solely determined by the state of its bottleneck link. This view was presented in one of the earliest congestion control algorithms. This helped the Internet recover from congestion collapse in 1988, and this view persisted throughout the more than 30 years of research and development that followed, including Google's new bandwidth and round-trip propagation time (BBR) algorithm. While it is generally true that a flow's performance is limited by the state of its bottleneck link, we describe a deeper view of network behavior, describing how bottlenecks interact with each other through a latent structure—called the bottleneck structure-that depends on the topological, routing, and flow control properties of the network. This latent structure explains how the performance of one bottleneck can affect other bottlenecks, and provides a framework to understand how perturbations in the capacity of a link or the rate of a flow propagate through a network, affecting other links and flows.

A related structure is described in co-pending U.S. patent application Ser. No. 16/580,718, (the “'718 application”) titled “Systems and Methods for Quality of Service (QoS) Based Management of Bottlenecks and Flows in Networks,” filed on Sep. 24, 2019, which is incorporated herein by reference in its entirety. The '718 application generally describes qualitative properties of the bottleneck precedence graph (BPG), a structure that analyzes the relationships among links. The '718 application is incorporated herein by reference in its entirety.

In the discussion below we present a quantitative theory of bottleneck structures (QTBS), a mathematical framework that yields a set of polynomial time and/or memory-efficient algorithms for quantifying the ripple effects of perturbations in a network. Perturbations can either be unintentional (such as the effect of a link failure or the sudden arrival of a large flow in a network) or intentional (such as the upgrade of a network link to a higher capacity or the modification of a route with the goal of optimizing performance). With QTBS, a network operator can quantify the effect of such perturbations and use this information to optimize network performance.

The techniques described herein are generally applicable to networks that transport commodity flows and also to systems that can be modeled as networks. In addition to communication networks, examples include (but are not limited to) vehicle networks, energy networks, fluidic networks, and biological networks. For example, the problem of vehicle networks generally involves identifying optimized designs of the road system that allows for a maximal number of vehicles that can circulate through the network without congesting it or, similarly, minimizing the level of congestion for a given number of circulating vehicles. In this case, vehicles are analogous to packets in a data network, while flows correspond to the set of vehicles going from location A to location B at a given time that follow the same path.

The capacity planning techniques described below can be used to analyze the need to construct a road to mitigate congestion hotspots, compute the right amount of capacity needed for each road segment, and to infer the projected effect on the overall performance of the road system. Similarly, the routing techniques described below can be used to suggest to drivers to choose alternative paths to their destination that would yield higher throughput or, equivalently, lower their destination arrival time.

The problem of energy networks generally includes transporting energy from the locations where energy is generated to the locations where it is consumed. For instance, energy can be in the form of electricity carried via the electrical grid. Other examples include fluidic networks, which can carry crude oil, natural gas, water, etc., or biological networks that may carry water, nutrients, etc.

Biological networks, through evolution, may tend to organize themselves in optimized structures that maximize their performance (in terms of transporting nutrients) and/or minimize the transportation costs. For instance, a tree transports sap from the root to its branches and in both directions. The sap transported from the root to its branches and leaves is called xylem, which carries energy and nutrients found from the soil where the tree is planted. The sap transported from the leaves and branches to the root is called phloem, which carries also important nutrients obtained from the biochemical process of photosynthesis performed in the cells of the leaves. In both networks (upward and downward), it is likely that the network transporting the sap performs optimally in terms of minimizing the amount of energy required to transport a given amount of sap. Such optimized designs can be generated for other types of networks, using the bottleneck structures and perturbation propagation based thereon, as discussed below. Biological networks can themselves be optimized based on such analysis.

Certain contributions of this disclosure are as summarized below:
A new generalized bottleneck structure called gradient graph is studied in detail. One difference with the bottleneck structure introduced in the '718 application is that the gradient graph allows us to not only qualify the influences that flows and bottlenecks exert on each other, but also to quantify them. This leads to the development of a quantitative theory of bottleneck structures (QTBS), discussed below. (Section 2.2)
A novel, fast procedure to compute the gradient graph is developed. Various aspects of this procedure/algorithm feature an asymptotic speed-up, allowing us to scale our methodology to large production networks (Section 2.2)
The concepts of link and flow gradient are introduced. These operators quantify the effects of infinitesimally small perturbations in a network, the core building blocks of QTBS. A new, fast method to efficiently compute the gradients by leveraging the bottleneck structure is also presented. (Section 2.3.)

Applications demonstrating the practical implications of QTBS are provided in the areas of routing, capacity planning, and flow control. In each of these applications, we show how QTBS can potentially alter some of the established conventional best practices. Some of our contributions regarding the application of QTBS are listed below:
In the routing application, we introduce a technique/algorithm to find maximal-throughput routes by anticipating the effects of the congestion control algorithm. While in traditional traffic engineering approaches the problems of routing and flow control are considered independently, we show how QTBS can help resolve them jointly, allowing operators to design routes that are efficient from a congestion control standpoint. (Section 3.1.)
In the capacity planning application, we use QTBS to optimize the bandwidth allocation between the spine and leaf links of a fat-tree (also known as folded-Clos). We demonstrate that, due to the effects of congestion control, the optimal design differs from the conventional full fat-tree configuration. (Section 3.2.)
In the flow control application, we show that QTBS can be used to precisely compute the rate reduction that a set of traffic shapers must impose on the network's low priority flows in order to achieve a quantifiable positive impact on the high-priority flows. (Section 3.3.) To demonstrate that networks behave according to QTBS, we carry out experiments for each application we consider using production TCP/IP code and the widely adopted BBR and Cubic congestion control algorithms. (Section 3.)

### 2 Theoretical Framework

### 2.1 Network Model

In their simplest form, networks are systems that can be modeled using two kinds of elements: links, which offer communication resources with a limited capacity; and flows, which make use of such communication resources. We formalize the definition of network as follows:

Definition 2.1 Network. We say that a tuple [symbol] = [symbol] , [symbol] , {cₗ, ∀l ∈ [symbol] } [symbol] is a network if:
[symbol] is a set of links of the form {l₁, l₂, . . . , l_{|} [symbol] _{|}}.
[symbol] is a set of flows of the form {ƒ₁, ƒ₂, . . . , [symbol] }, and
cₗ is the capacity of link l, for all l ∈ [symbol] .

Each flow ƒ traverses a subset of links [symbol] _{ƒ} ⊂ [symbol] and, similarly, each link l is traversed by a subset of flows [symbol] ₗ ⊂ [symbol] . We will also adopt the convenient notation ƒ= [symbol] _{ƒ} and l= [symbol] ₗ. That is, a flow is the list of links that it traverses, and a link is the list of flows that traverse it. Finally, each flow ƒ transmits data at a rate r_{ƒ} and the capacity constraint Σ_{∀ƒ∈l}r_{ƒ}≤cₗ must hold for all l ∈ [symbol] .

A core concept upon which our framework resides is the notion of a bottleneck link. Intuitively, a link in a network is a bottleneck if its capacity is fully utilized. Mathematically and in the context of this work, we will use a more subtle definition:

Definition 2.2 Bottleneck link. Let [symbol] =( [symbol] , [symbol] , {cₗ, ∀l ∈ [symbol] } [symbol] be a network where each flow ƒ ∈ [symbol] transmits data at a rate r_{ƒ} determined by a congestion control algorithm (e.g., TCP's algorithm). We say that flow ƒ is bottlenecked at link l—equivalently, that link l is a bottleneck to flow ƒ—if and only if:

Flow ƒ traverses link l, and

$$\frac{\partial {r}_{f}}{\partial {c}_{l}^{-}} \neq 0 .$$

That is, the transmission rate of flow ƒ changes upon small changes of link l's capacity. We use the notation

$$\frac{\partial {r}_{f}}{\partial {c}_{l}^{-}}$$

to denote the left derivative. This subtlety is necessary because a flow can have multiple bottleneck links. In this case, decreasing the capacity of only one bottleneck would affect the rate of the flow, while increasing its capacity would not; thus, the (two-sided) derivative would not exist.

This definition of bottleneck generalizes some of the classic definitions found in the literature, while differing from them in that it focuses on the notion of perturbation, mathematically expressed as a derivative of a flow rate with respect to the capacity of a link,

$$\frac{\partial {r}_{f}}{\partial {c}_{l}} .$$

(Our definition of bottleneck is relatively flexible, as the definition corresponds to a generalization of the classic max-min definition.) The general character of the bottleneck definition used in various aspects described herein is relevant in that it makes our framework applicable not just to specific rate allocation assignments (e.g., max-min, proportional fairness, etc.) or to specific congestion control algorithms (e.g., BBR, Cubic, Reno, etc.), but to any class of congestion control solutions, such as those available in today's networks and those may be developed subsequently, provided that the two conditions in Definition 2.2 hold.

We complete the description of the network model introducing the concept of fair share:

Definition 2.3 Fair share of a link. Let [symbol] = [symbol] , [symbol] , {cₗ, ∀l ∈ [symbol] } [symbol] be a network. The fair share si of a link l ∈ [symbol] is defined as the rate of the flows that are bottlenecked at such link.

The flows bottlenecked at a link may all have the same rate that may be the same as the fair share of the link. As used throughout the discussion below, the concept of link fair share is dual to the concept of flow rate. That is, all the mathematical properties that are applicable to the rate of a flow, are also applicable to the fair share of a link.

### 2.2 The Gradient Graph

Our objective is to derive a mathematical framework capable of quantifying the effects that perturbations on links and flows exert on each other. Because the bottleneck structure described in U.S. patent application Ser. No. 16/580,718 considers only the effects between bottleneck links, we need a generalization of such structure that can also describe the effects of perturbations on flows. We refer to this data structure as the gradient graph, formally defined as follows (the name of this graph derives from the fact that perturbations can mathematically be expressed as derivatives or, more generically, as gradients):

Definition 2.4A Gradient graph. The gradient graph is a digraph such that:
1. For every bottleneck link and for every flow, there exists a vertex.
2. For every flow ƒ:
   (a) If ƒ is bottlenecked at link l, then there exists a directed edge from l to ƒ;
   (b) If ƒ is not bottlenecked at link l but it traverses it, then there exists a directed edge from ƒ to l.

We may also employ a variation of the Definition 2.4A as:

Definition 2.4B Gradient graph. The gradient graph is a digraph such that:
1. For every bottleneck link and for every flow, there exists a vertex.
2. For every flow f:
   (a) If ƒ is bottlenecked at link l, then there exists a directed edge from l to ƒ;
   (b) If ƒ traverses link l, then there exists a directed edge from ƒ to l.

By way of notation, in the discussion below we will use the terms gradient graph and bottleneck structure indistinguishably. Intuitively, a gradient graph describes how perturbations on links and flows propagate through a network as follows. A directed edge from a link l to a flow ƒ indicates that flow ƒ is bottlenecked at link l (Condition 2(a) in Definitions 2.4A and 2.4B). A directed edge from a flow ƒ to a link l indicates that flow ƒ traverses but is not bottlenecked at link l (Condition 2(b) in Definition 2.4A), and a bidirectional edge from a flow ƒ to a link l indicates that flow f traverses (and is bottlenecked at) link l (Condition 2(b) in Definition 2.4B).

From Definition 2.2, this necessarily implies that a perturbation in the capacity of link l will cause a change on the transmission rate of flow ƒ,

$$\frac{\partial {r}_{f}}{\partial {c}_{l}^{-}} \neq 0 .$$

A change in the value of r_{ƒ}, in turn, creates a perturbation that propagates to all the other links traversed by flow ƒ, following the direction of those edges departing from flow ƒ and arriving at such links (Conditions 2(b) in Definitions 2.4A or 2.4B). This basic process of (1) inducing a perturbation in a vertex in a graph (either in a link or a flow vertex) followed by (2) propagations in the departing edges of the vertex, creates a ripple effect in the bottleneck structure, terminating at the leaves of the gradient graph.

The utility of our definition of gradient graph as a data structure for understanding network performance is captured in the following theorem.

Theorem 2.5 Propagation of network perturbations.

Let x, y ∈ [symbol] ∪ [symbol] be a pair of links or flows in the network. Then a perturbation in the capacity cₓ (for x ∈ [symbol] ) or transmission rate rₓ (for x ∈ [symbol] ) of x will affect the fair share s_{y} (for y ∈ [symbol] ) or transmission rate r_{y} (for y ∈ [symbol] ) of y if only if there exists a directed path from x to y in the gradient graph.
1. The following characterizes the propagation of a perturbation in a bottleneck link:
   (a) A perturbation in a link l induced by a change on its capacity cₗ will propagate to another link l′ affecting its fair share sₗ′ if and only if l′ is a descendant of l in the gradient graph.
   (b) A perturbation in a link l induced by a change on its capacity cₗ will propagate to a flow ƒ affecting its transmission rate r_{ƒ} if and only if ƒ is a descendant of l in the gradient graph.
2. Let ƒ be a flow bottlenecked at link l. The following characterizes the propagation of a perturbation in a flow:
   (a) A perturbation in ƒ induced by a change on its transmission rate r_{ƒ} will propagate to a link l′ affecting its fair share s_{l′} if and only if l′ is a descendant of l in the gradient graph.
   (b) A perturbation in ƒ induced by a change on its transmission rate r_{ƒ} will propagate to a flow ƒ′ affecting its transmission rate r_{ƒ′} if and only if ƒ′ is a descendant of l in the gradient graph.

Intuitively, the gradient graph of a network describes how perturbations in link capacities and flow transmission rates propagate through the network. Imagine that flow ƒ is bottlenecked at link l. From Definition 2.2, this necessarily implies that a perturbation in the capacity of link l will cause a change on the transmission rate of flow ƒ,

$$\frac{\partial {r}_{f}}{\partial {c}_{l}} \neq 0 .$$

This is reflected in the gradient graph by the presence of a directed edge from a link l to a flow ƒ (Condition 2a in Definitions 2.4A and 2.5B). A change in the value of r_{ƒ}, in turn, affects all the other links traversed by flow ƒ. This is reflected by the directed edges from ƒ to the links it traverses (e.g., Condition 2b in Definition 2.4B). This basic process of (1) inducing a perturbation in a vertex (either in a link or a flow vertex) followed by (2) propagating the effects of the perturbation along the departing edges of the vertex creates a ripple effect in the bottleneck structure as described in Theorem 2.5. Leveraging Theorem 2.5, we are now in a position to formally define the regions of influence of a data network.

Definition 2.6 Regions of influence in a data network. We define the region of influence of a link or flow x, denoted as [symbol] (x), as the set of links and flows y that are reachable from x in the gradient graph.

In the case of the region of influence of a link l, the other links and flows are affected by a perturbation in the capacity cₗ of link l, according to Theorem 2.5. Similarly, in the case of the region of influence of a flow ƒ, the set of links and other flows are affected by a perturbation in the transmission rate r_{ƒ} of flow ƒ, according to Theorem 2.5.

From Theorem 2.5, we know that the region of influence of a link (or a flow) corresponds to its descendants in the gradient graph. The region of influence is an important concept in network performance analysis and optimization because it describes what parts of a network are affected by perturbations in the performance of a link or a flow. In Section 2.3, it is discussed how such influences can be quantified using the concept of link and flow gradient.

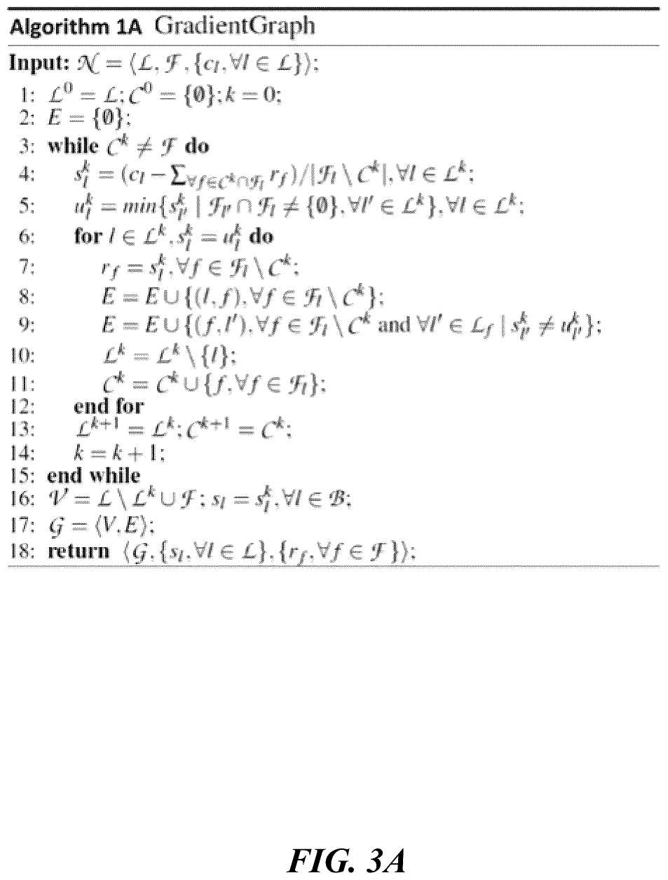

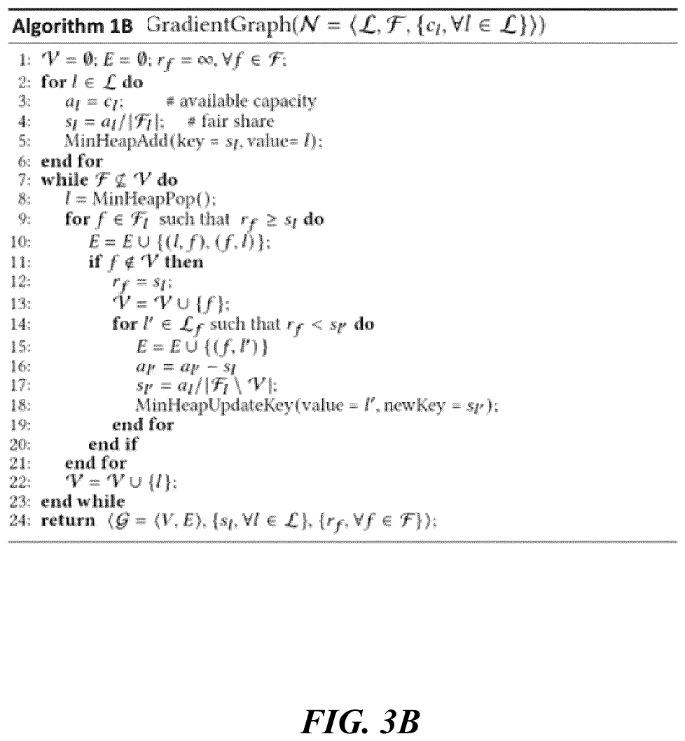

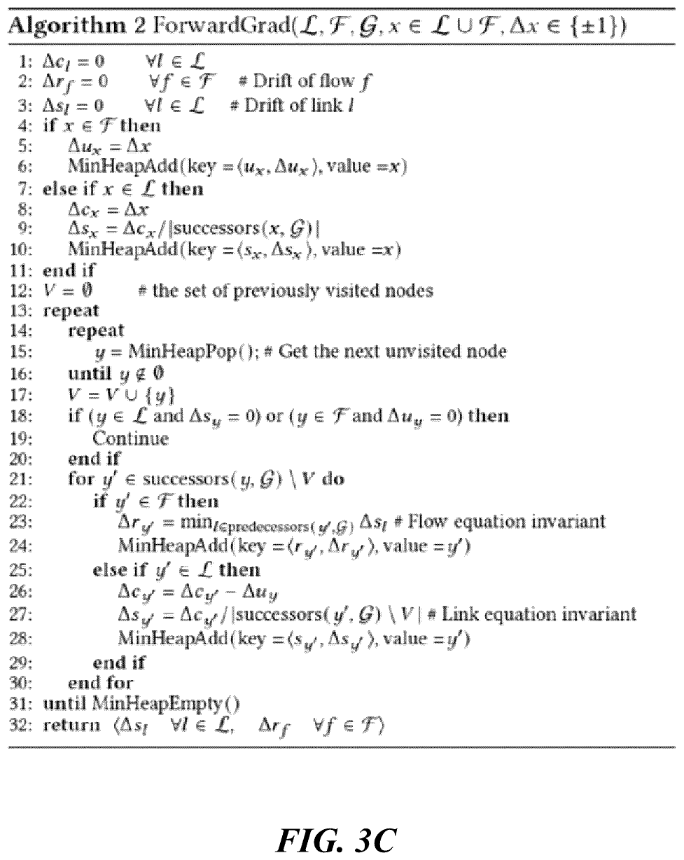

We now introduce the GradientGraph (Algorithm 1A, FIG. 3A), an aspect of a procedure that computes the gradient graph of a network. The algorithm works as follows. In line 4, a fair share (Definition 2.3) estimate of each link is computed. Lines 5 and 6 select all links that currently have the smallest fair share among those links with which they share a flow. For each of these links: (1) all the flows remaining in the network that traverse them are assigned the fair share of the link (line 7), removed from the network (line 10) and put into the set of flows that have converged to their theoretical transmission rate [symbol] ^{k} (line 11); (2) the link itself is also removed (line 10); and (3) directed edges are added to the gradient graph that go from the link to all the flows bottlenecked at it (line 8) and from each of these flows to the rest of the links that they traverse (line 9). This iterative process is repeated until all flows have converged to their theoretical rate (line 3). The algorithm returns the gradient graph [symbol] , the fair share of each link {sₗ, ∀l ∈ [symbol] } and the rate of each flow {r_{ƒ}, ∀ƒ ∈ [symbol] }.

Lemma 2.7A states the time complexity of the GradientGraph algorithm:

Lemma 2.7A Time complexity of the GradientGraph algorithm. The time complexity of running GradientGraph( ) is O(H·| [symbol] |²+| [symbol] |·| [symbol] |), where H is the maximum number of links traversed by any flow.

FIG. 3B shows another aspect of GradientGraph (Algorithm 1B). In this aspect, the algorithm begins with crude estimates of the fair share rates of the links, and iteratively refines them until all the capacity in the network has been allocated and the rate of each flow reaches its final value. In the process, the gradient graph is constructed level by level. The algorithm starts by initializing the available capacity of each link (line 3), estimating its fair share (line 4), and adding all links to a min-heap by taking their fair share value as the key (line 5). At each iteration, the algorithm picks the unresolved link with the lowest fair share value from the min-heap (line 8).

Once this link is selected, all unresolved flows remaining in the network that traverse it are resolved. That is, their rates are set to the fair share of the link (line 12) and they are added to the set of vertices of the gradient graph V (line 13). In addition, directed edges are added in the gradient graph between the link and all the flows bottlenecked at it (line 10) and from each of these flows to the other links that they traverse (line 15). Lines 16-17-18 update the available capacity of the link, its fair share, and the position of the link in the min-heap according to the new fair share. Finally, the link itself is also added as a vertex in the gradient graph (line 22). This iterative process may be repeated until all flows have been added as vertices in the gradient graph (line 7). The algorithm returns the gradient graph G, the fair share of each link {sₗ, ∀l ∈ [symbol] } and the rate of each flow {r_{ƒ}, ∀_{ƒ ∈} [symbol] _{}.}

Lemma 2.7B provides the run-time complexity of this aspect of the GradientGraph( ) algorithm:

Lemma 2.7B. Time complexity of GradientGraph( ). The time complexity of running GradientGraph( ) is O(|L| log |L|·H), where H is the maximum number of flows that traverse a single link.

The GradientGraph is memory efficient, as well. In particular, various aspects of the GradientGraph include a respective vertex for each link and a respective vertex for each flow. As such, the number of vertices in a GradientGraph is O(| [symbol] |+| [symbol] |). The edges in the graph from a link vertex to one or more flow vertices do not include, however, an edge to each and every flow vertex where that flow vertex represents a flow traversing the link corresponding to the link vertex. Rather, edges exist from a link vertex to a flow vertex only if, as described above, a flow corresponding to that flow vertex is bottlenecked at the link corresponding to the link vertex. This minimizes the total number of edges in various aspects and implementations of GradientGraph.

Since the memory required to construct a GradientGraph is a function of (e.g., proportional to the total number of vertices and the total number of edges, the identification of the bottleneck structure facilitates efficient memory allocation in various aspects. Specifically, in some cases, the memory to be allocated can be a function of the total number of link vertices to flow vertices edges, denoted (|E_{b}^{l→ƒ}|) where |E_{b}^{l→ƒ}| is a sum of the number of bottlenecked flows at each link. The required memory may be proportional to O(| [symbol] |+| [symbol] |+|E|), where the set {E} includes the set of edges from flow vertices to link vertices, denoted {E^{l→ƒ}} and the set of edges from link vertices to flow vertices corresponding to bottlenecked flows, denoted {E^{l→ƒ}}. In some cases, the total number of flows bottlenecked at a link l is less than the total number of flows traversing the link l, minimizing the number of edges |E^{l→ƒ}|.

Since, for one or more links, all flows traversing such links may not be bottlenecked at those respective links, the total number of link-to-flow edges (or the total number of bidirectional link-to-flow edges) that are required may be minimized compared to a network graph structure having, for each link, and edge from a corresponding link vertex to vertices corresponding to all flows traversing the link. This can facilitate a memory efficient storage of the gradient graph. Thus, the derivation of the bottleneck structure can minimize the memory required to store and manipulate such a structure, in various aspects.

### 2.3 Link and Flow Gradients

In this section, we focus on the problem of quantifying the ripple effects created by perturbations in a network. Because networks include links and flows, generally there are two possible causes of perturbations: (1) those originating from changes in the capacity of a link and (2) those originating from changes in the rate of a flow. When such changes occur, the congestion control algorithm typically adjusts its allocation of bandwidth to the flows so as to maintain two objectives: (1) maximizing network utilization while (2) ensuring fairness among competing flows. The congestion control algorithm acts like a function mapping network conditions (including its topology, link capacities, and flow paths) to rate allocations. Large changes in any of these inputs can have complicated ripple effects on the flow rates, but for sufficiently small changes, the bandwidth allocation function is linear. Technically, it is piecewise linear, like the absolute value function, so picking a linear function that locally approximates it requires knowing the direction of the change. This local linearity property is used to form the concept of link and flow gradients:

Definition 2.8 Link and flow gradients. Let [symbol] = [symbol] , [symbol] , {cₗ, ∀l ∈ [symbol] } [symbol] be a network. We define:

The gradient of a link l* ∈ [symbol] with respect to some other link l ∈ [symbol] , denoted with

$${∇}_{l}^{*} ( l ) , as {∇}_{l}^{*} ( l ) = \frac{\partial {s}_{l}}{\partial {c}_{l}^{*}} .$$

The gradient of a link l* ∈ [symbol] with respect to some flow ƒ ∈ [symbol] , denoted with ∇_{l*}(ƒ), as

$${∇}_{l}^{*} ( f ) = \frac{\partial {r}_{f}}{\partial {c}_{l}^{*}} .$$

The gradient of a flow ƒ* ∈ [symbol] with respect to some link l ∈ [symbol] , denoted with ∇_{ƒ*}(l), as

$${∇}_{f}^{*} ( l ) = \frac{\partial {s}_{l}}{\partial {r}_{f}^{*}} .$$

The gradient of a flow ƒ* ∈ [symbol] with respect to some other flow ƒ ∈ [symbol] , denoted with ∇_{ƒ*}(ƒ), as

$${∇}_{f}^{*} ( f ) = \frac{\partial {r}_{f}}{\partial {r}_{f}^{*}} .$$

Intuitively, the gradient of a link measures the impact that a fluctuation on the capacity of a link has on other links or flows. In real networks, this corresponds to the scenario of physically upgrading a link or, in programmable networks, logically modifying the capacity of a virtual link. Thus, link gradients can generally be used to resolve network design and capacity planning problems. Similarly, the gradient of a flow measures the impact that a fluctuation on its rate has on a link or another flow. For instance, this scenario corresponds to the case of traffic shaping a flow to alter its transmission rate or changing the route of a flow—which can be seen as dropping the rate of that flow down to zero and adding a new flow on a different path. Thus, flow gradients can generally be used to resolve traffic engineering problems. (In Section 3 applications in real networks that illustrate each of these scenarios are provided.)

Before describing how link and flow gradients can be efficiently computed using the gradient graph, we introduce the concept of flow drift:

Definition 2.9 Drift. Let [symbol] = [symbol] , [symbol] , {cₗ, ∀l ∈ [symbol] } [symbol] be a network and assume [symbol] , {sₗ, ∀l ∈ [symbol] }, {r_{ƒ}, ∀ƒ ∈ [symbol] } [symbol] is the output of GradientGraph(N) (Algorithms 1A or 1B). Let δ be an infinitesimally small perturbation performed on the capacity of a link l* ∈ [symbol] (equivalently, on the rate of a flow ƒ* ∈ [symbol] ). Let also sₗ+Δₗ and r_{ƒ}+Δ_{ƒ} be the fair share of any link l ∈ [symbol] and the rate of any flow ƒ ∈ [symbol] , respectively, after the perturbation δ has propagated through the network. We will call Δₗ and Δ_{ƒ} the drift of a link l and a flow ƒ, respectively, associated with perturbation δ.

Intuitively, the drift corresponds to the change of performance experienced by a link or a flow when another link or flow is perturbed. With reference to FIG. 3C, we now present an algorithm called ForwardGrad( ) (Algorithm 2) for calculating link and flow gradients. The algorithm takes a set of links and flows, the gradient graph of the corresponding network, a link or flow x with respect to which to compute the gradients, and a direction Δx of the perturbation. It outputs the gradients of all links and flows in the network with respect to x. ForwardGrad( ) is related to forward mode automatic differentiation (“Forward Prop”), an algorithm that uses directed acyclic graphs to represent complicated mathematical functions as compositions of simpler functions, whose derivatives can be composed by repeatedly applying the chain rule. In the case of congestion control, we do not have a closed-form mathematical formula that relates network conditions (the inputs) to the flow rates and fair share values (the outputs) and, as such, Forward Prop cannot be used in this context. But we can use the gradient graph to break down and optimize this function.

The thrust of the algorithm is as follows. For all l ∈ [symbol] , let Δₗ be the change in the fair share rate of link l. For all ƒ ∈ z,97 , let Δ_{ƒ} be the change in the rate of flow ƒ. We call these variables the “drifts” caused by a perturbation. Before the perturbation, Δₗ=Δ_{ƒ}=0 for all links and flows. To begin the algorithm, we make an infinitesimally small perturbation in the independent variable (the one in the “denominator” of the derivative) that can be positive or negative. If the independent variable x is a flow ƒ, we set Δ_{ƒ}=8 (line 2). If it is a link l, and Sₗ is the set of direct successors of node l in the gradient graph, we set Δₜ=δ S₁ (line 3). This is done since, by definition of the gradient graph, Sₗ is the number of flows bottlenecked at l and the change in l's capacity will be distributed evenly among these flows. To determine how this perturbation propagates to the rest of the network, we follow all directed paths from that vertex and update the drifts according to the following two invariants:

Gradient graph invariants. Let [symbol] = [symbol] , [symbol] , {cₗ, ∀l ∈ [symbol] } [symbol] be a network and let [symbol] be its gradient graph. Let δ be an infinitesimally small perturbation performed on the capacity of a link l* ∈ [symbol] (equivalently, on the rate of a flow ƒ* ∈ [symbol] ) and let At and Δ₇₁ be the drifts caused on a link l ∈ [symbol] and a flow ƒ ∈ [symbol] , respectively, by such a perturbation. Assume also that the perturbation propagates according to the gradient graph [symbol] by starting on the link vertex l* (equivalently, on the flow vertext f*) and following all possible directed paths that depart from it, while maintaining the following invariants at each traversed vertex:

Invariant 1: Flow Equation. A flow's drift Δ_{ƒ} equals the minimum drift of its bottleneck links. That is,

$${Δ}_{f} = {min}_{l ∈ {P}_{f}} {Δ}_{l} ,$$

where P_{ƒ} is the set of links visited directly before flow vertex ƒ on a path from the starting vertex x (the predecessors in the graph).

Invariant 2: Link Equation. A link's drift Δₗ is the negative of the flow drifts entering its vertex, divided by the number of flow drifts leaving it. That is, Δₗ=−Σ_{ƒ∈P}_{ₗ}Δ_{ƒ}/|Sₗ|, where Pₗ is the set of flow vertices visited directly before link vertex l and Sₗ is the set of flow vertices visited directly after link vertex l on a path from the starting vertex x.

Finally, the derivative of a given variable with respect to the independent variable that we perturbed can be calculated by dividing its drift by δ. In particular, assume the capacity of link l is the independent variable that we perturbed and let the rate of flow ƒ be the dependent variable in which we want to measure the effect of this perturbation. Then, ∂r_{ƒ}/∂cₗ=Δ_{ƒ}/δ.

Since the flow and link equations lie at the heart of the algorithm, we provide some further explanation. Invariant 1 ensures that the capacity limits are respected and the network's resources are not wasted. Each flow must use exactly the amount of bandwidth allocated by its bottleneck link, so if the bottleneck's fair share changes, the flow's rate must change too. It also ensures fairness, since each flow bottlenecked at a certain link will experience the same drift. Invariant 2 ensures that capacity is neither created nor destroyed through the process of propagating a perturbation, except at the link whose capacity was initially perturbed. If a link's predecessors are using less bandwidth than before, then the savings must be redistributed evenly among the other flows that traverse the link.

Let also [symbol] ′ be the gradient graph of the resulting network after the perturbation has propagated. Then, if [symbol] = [symbol] ′, the link and flow gradients can be computed as follows:

$${∇}_{{l}^{*}} ( l ) = \frac{\partial {s}_{l}}{\partial {c}_{{l}^{*}}} = \frac{{Δ}_{l}}{δ} ; \text{} {∇}_{{l}^{*}} ( f ) = \frac{\partial {r}_{f}}{\partial {c}_{{l}^{*}}} = \frac{{Δ}_{f}}{δ} ; {∇}_{{f}^{*}} ( l ) = \frac{\partial {s}_{l}}{\partial {r}_{{f}^{*}}} = \frac{{Δ}_{l}}{δ} ; {∇}_{{f}^{*}} ( f ) = \frac{\partial {r}_{f}}{\partial {r}_{{f}^{*}}} = \frac{{Δ}_{f}}{δ} .$$

This states that if the gradient graph does not change its structure upon a small perturbation (e.g., [symbol] = [symbol] ′) and the two invariants are preserved, then such a perturbation can be measured directly from the graph. The first invariant is a capacity feasibility constraint, ensuring that a flow's drift is limited by its most constrained bottleneck. The second invariant ensures that (1) the sum of the drifts arriving to and departing from a link vertex are equal to zero and (2) the drifts departing from a link vertex are equally distributed. Intuitively, this is needed to preserve the congestion control algorithm's objective to maximize network utilization while ensuring fairness among all flows.

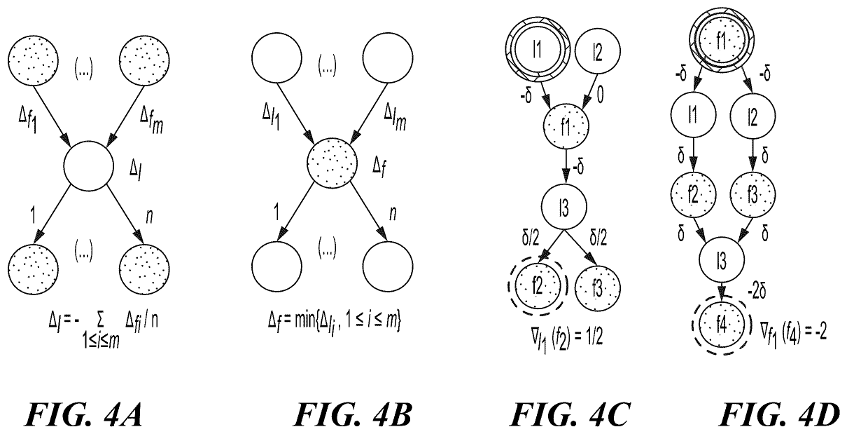

FIGS. 4A and 4B show a graphical interpretation of the link and flow equations. FIG. 4C illustrates a simple example to compute the link gradient ∇ₗ_{₁}(ƒ₂). A perturbation is applied to link l₁ that decreases its capacity cₗ_{₁} by an infinitesimally small amount δ. Such a perturbation propagates to flow ƒ₁ according to the flow equation (Δ_{ƒ}=min{Δₗ_{ᵢ}, 1≤i≤m}), resulting in a drift Δ_{ƒ}_{₁}=−δ. The perturbation is further propagated down to link l₃. Applying the link equation

$$( {Δ}_{l} = - \frac{{\sum }_{1 \leq i \leq m} {Δ}_{{f}_{i}}}{n} ) ,$$

this generates a drift on this link of

$${Δ}_{{l}_{3}} = \frac{δ}{2} .$$

Applying again the flow equation on ƒ₂, we obtain the flow drift

$${Δ}_{{f}_{2}} = \frac{δ}{2} .$$

Thus, the gradient of link l₁ with respect to flow ƒ₂ is

$${∇}_{{l}_{1}} ( {f}_{2} ) = \frac{{Δ}_{{f}_{2}}}{δ} = \frac{1}{2} .$$

FIG. 4D illustrates a simple example of flow gradient computation which shows that for this bottleneck structure, the gradient of flow ƒ₁ with respect to flow ƒ₄ is ∇_{ƒ}_{₁}(ƒ₄)=−2.

It should be noted that it is feasible for a link or flow gradient to have a value larger than 1. Such gradients are of interest because they mean that an initial perturbation of one unit at some location of a network, generates a perturbation at another location of more than one unit. For instance, a gradient of the form ∇_{ƒ*}(ƒ)>1 implies that reducing the rate of flow ƒ* by one unit creates a perturbation that results in an increase on the rate of flow ƒ by more than one unit, thus creating a multiplicative effect. Such gradients can be used to identify arbitrage situations—e.g., configurations of the network that increase the total flow of a network. Because of their relevance, we will use the term power gradient to refer to such effect:

Definition 2.10 Power gradient. Let [symbol] = [symbol] , [symbol] , {c₁, ∀l ∈ [symbol] } [symbol] be a network and let δ be an infinitesimally small perturbation performed on a flow or link x ∈ [symbol] ∪ [symbol] , producing a drift Δ_{y}, for all y ∈ [symbol] ∪ [symbol] . If Δ_{y}>δ, equivalently ∇ₓ(y)>1, then we will say that ∇ₓ(y) is a power gradient. In Section 3, we provide examples of power gradients. For now, we conclude this section stating a property of boundedness that all gradients in congestion-controlled networks satisfy:

Property 1 Gradient bound. Let [symbol] = [symbol] , [symbol] , {c1, ∀l ∈ [symbol] } [symbol] be a network and let [symbol] be its gradient graph. Let δ be an infinitesimally small perturbation performed on a flow or link x ∈ L ∪ [symbol] , producing a drift Δ_{y}, for all y ∈ L∪ [symbol] . Then.

$${∇}_{x} ( y ) = \frac{{Δ}_{y}}{δ} \leq {d}^{\frac{D ( 𝒢 )}{4}} ,$$

where D(X) is the diameter function of a graph X and d is the maximum indegree and outdegree of any vertex in the graph.

### 2.4 Leaps and Folds

The concepts of link and flow gradients introduced in the previous section provide a methodology to measure the effect of perturbations on a network that are small enough (infinitesimally small) to avoid a structural change in the gradient graph. In this section, we introduce the concepts of leap and fold, which allow us to generalize the framework to measure perturbations of arbitrary sizes. Two simple and intuitive examples of such kind of perturbations found in real networks include: a link failure, which corresponds to the case its capacity goes down to zero; or the re-routing of a flow, which corresponds to the case its rate goes down to zero and a new flow is initiated.

We know that if a perturbation in the network is significant enough to modify the structure of the gradient graph (e.g., [symbol] ≠ [symbol] ′), then the link and flow equations (FIGS. 4A and 4B) cannot be used to compute the gradients of such a perturbation. In this section, we present a technique that can be used to measure perturbations of arbitrary sizes by using the concepts of leap and fold:

Definition 2.11 Gradient leap. Let ∇ₓ(y) be a gradient resulting from an infinitesimally small perturbation δ on a link or flow x, where x, y ∈ [symbol] ∪ [symbol] . Suppose that we intensify such a perturbation by a factor k, resulting in an actual perturbation of λ=k·δ, for some k>0. Further, assume that k is the largest possible value that keeps the structure of the gradient graph invariant upon perturbation λ. Then, we will say that λ is the leap of gradient ∇ₓ(y).

The following lemma shows the existence of folds in the bottleneck structure when its corresponding network is reconfigured according to the direction indicated by a gradient and by an amount equal to its leap:

Lemma 2.12 Folding links. Let [symbol] = [symbol] , [symbol] , {cₗ, ∀l ∈ [symbol] } [symbol] be a network and let [symbol] be its gradient graph. Let λ be the leap of a gradient ∇ₓ(y), for some x, y ∈ [symbol] ∪ [symbol] . Then, there exist at least two links l and l′ such that: (1) for some f ∈ [symbol] , there is a directed path in [symbol] of the form l→f→l′; and (2) sₗ=sₗ′ after the perturbation has propagated through the network.

Intuitively, the above lemma states that when a perturbation is large enough to change the structure of the gradient graph, such structural change involves two links l and l′ directly connected via a flow ƒ (e.g., forming a path l→ƒ→l′) that have their fair shares collapse on each other (s′ₗ=s′_{l′}) after the perturbation has propagated. The faire shares can be substantially or approximately equal (e.g., the difference between the faire shares can be zero or less than a specified threshold, e.g., 10%, 5%, 2%, 1%, or even less of the fair share of one of the links.) Graphically, this corresponds to the folding of two consecutive levels in the bottleneck structure. We can now formalize the definition of fold as follows.

Definition 2.13 Fold of a gradient. Let A be the leap of a gradient ∇ₓ(y), for some x, y ∈ [symbol] ∪ [symbol] , and let l and l′ be two links that fold once the perturbation λ has propagated through the network (note that from the discussion above, such links must exist). We will refer to the tuple (l, l′) as a fold of gradient ∇ₓ(y).

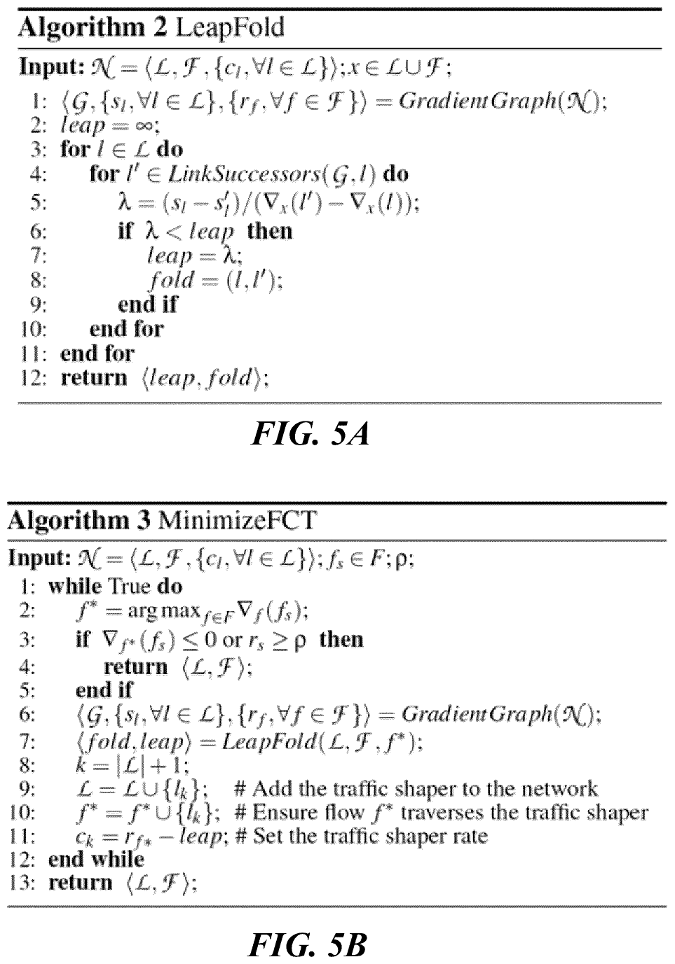

FIG. 5A introduces Algorithm LeapFold( ), a procedure to compute the leap and the fold of a link or flow gradient. Intuitively, for each pair of link vertices l and l′ in the bottleneck structure that are directly connected via a flow vertex (in line 4, l′ is a link successor of l), we compute the maximum amount λ that can be traveled along the gradient without the collision of the two links' fair share (line 5). The minimum value of λ among all such pairs of links corresponds to the leap (line 7), while the links themselves constitute a fold (line 8). The algorithm returns both the leap and the fold (line 12).

The concept of leap and fold is relevant in that it enables a methodology to efficiently travel along the solution space defined by the bottleneck structure, towards reaching a certain performance objective is achieved. Specifically, for some x, y ∈ [symbol] ∪ [symbol] , if x is perturbed negatively so as to benefit another flow or link in the network, but only up to the leap of x, e.g., λ, the negative and positive changes may be balanced. On the other hand, if x is perturbed negatively by more than its λ, the positive impact of this perturbation on another flow or link would not exceed λ, potentially resulting in degradation of the overall network performance.

We introduce a method/algorithm Minimize FCT( ) shown in FIG. 5B, that can identify a set of perturbations needed in a network to minimize the completion time of a given flow ƒₛ (also referred to as flow completion time (FCT)). The algorithm starts (line 2) by identifying a maximal gradient ∇_{ƒ*}(ƒₛ). This corresponds to a direction in the solution space that improves the performance of ƒₛ maximally. Then, it travels along such gradient by an amount equal to its leap (lines 6 through 11). This is achieved by adding a logical link lₖ that acts as a traffic shaper reducing the rate of flow ƒ* by the leap amount. This causes the intended perturbation, thus resulting in the increase of flow ƒₛ's rate by the amount leap×∇_{ƒ*}(ƒₛ).

From the discussion above, we know that the additional traffic shaper changes the structure of the gradient graph, at which point we need to iterate again the procedure (line 1) to recompute the new values of the gradients based on the new structure. This process is repeated iteratively until either no more positive gradients are found or the performance of ƒₛ has increased above a given rate target ρ (lines 3 and 4). In the next section, an example is presented demonstrating how aspects of MinimizeFCT( ) may be used to optimize the performance of a time-bound constrained flow.

To provide the process illustrated using FIGS. 4A-4D into a precise algorithm, we still must specify the order in which to process the vertices of the graph. At each step, the vertex we process must be a neighbor of one of the vertices we have already visited. Even though backward edges create loops in the gradient graph, we never visit a vertex twice. If multiple vertices meet these criteria, we pick the one with the minimal rate or fair share value. If there are multiple vertices with the minimal rate or fair share value, we pick the one that would receive the minimum drift if it were processed next (see line 15, Algorithm 2, FIG. 3C) where keys in the heap are ordered pairs of rate/fair share and drift). This reflects the order in which the bottleneck structures are constructed in Algorithm 1B, which reflects the order in which the rates and fair shares converge in congestion-controlled networks. That is, we first visit the vertex that would receive the smallest rate or fair share if the perturbations were applied and bandwidth were reallocated from scratch. This completes the description of the ForwardGrad( ) algorithm.

The next two theorems show that Algorithm 2 is both correct and efficient.

Theorem 2.9. Correctness of ForwardGrad( ) Let [symbol] = [symbol] , [symbol] , {cₗ, ∀l ∈ [symbol] } [symbol] be a network and let [symbol] be the corresponding gradient graph. Let x ∈ [symbol] ∪ [symbol] . After running Algorithm 2, Δsₗ=∇ₓ(l) for all l ∈ [symbol] , and Δr_{ƒ} =∇ₓ(ƒ), for all ƒ ∈ [symbol] .

Theorem 2.10. Time complexity of ForwardGrad( ) Let x ∈ [symbol] ∪ [symbol] . Then Algorithm 2 finds the gradients of all links and flows in the network with respect to x in time O(| [symbol] (x)|· log(| [symbol] (x)|)

To conclude and complement this section, we state an upper bound on the value of the gradients:

Property 2.11. Gradient bound. Let [symbol] = [symbol] , [symbol] , {cₗ, ∀l ∈ [symbol] } [symbol] be a network and let [symbol] be its gradient graph. Let δ be an infinitesimally small perturbation performed on a flow or link x ∈ [symbol] ∪ [symbol] , producing a drift Δ_{y}, for all y ∈ [symbol] ∪ [symbol] . Then,

$$\vert {∇}_{x} ( y ) \vert = \frac{\vert {Δ}_{y} \vert}{δ} \leq {d}^{\frac{D ( 𝒢 )}{4}} ,$$

where D(X) is the diameter of a graph X and d is the maximum indegree and outdegree of any vertex in the graph.

### 3 Applications to Data Networks and Experimental Results

Because bottleneck structures are a fundamental property intrinsic to any congestion-controlled data network, its applications span a variety of networking problems. In this section, our goal is to present examples and experiments illustrating how QTBS can be used to resolve some of these problems. We will see that in each of them, the framework is able to provide new insights into one or more operational aspects of a network. The examples presented in this section are not exhaustive, but only illustrative. To help organize the applications, we divide them in two main classes: traffic engineering and capacity planning. For each of these classes, we provide specific examples of problems that relate to applications commonly found in modern production networks.

To experimentally demonstrate that data networks behave qualitatively and quantitatively according to QTBS, we use Mininet-Extensions-Anonymized, a network emulation framework developed by our team that consists of a set of software modules and extensions to Mininet. Leveraging software define networking (SDN), Mininet-Extensions-Anonymized enables the creation and analysis of arbitrary network architectures using real production TCP/IP code, including production-grade implementations of congestion control algorithms such as BBR, Cubic or Reno.

All the experimental results presented in this section are based on Google's BBR congestion control algorithm and Cubic. For each experiment, we used Jain's fairness index as an estimator to measure how closely the predictions of the theory of bottleneck structure model match the experimental results. For all BBR experiments presented in the next sections, this index was above 0.99 accuracy on a scale from 0 to 1, reflecting the strength of QTBS in modeling network behavior.

### 3.1 Traffic Engineering: Computation of the Highest-Throughput Route

In traditional IP networks, the problems of flow routing and congestion control are separately resolved by following a two-step process: first, a routing protocol (e.g., border gateway protocol (BGP), (open shortest path first OSPF), etc.) is used to determine the path between any two nodes in a network; then, flows are routed according to such paths and their transmission rates are regulated using a congestion control algorithm (e.g., BBR). This layered and disjoint approach is known generally to be scalable but suboptimal because the routing algorithm identifies paths without taking into account the flow transmission rates assigned by the congestion control algorithm. In this section, we use QTBS to resolve the following joint routing and congestion control problem in a scalable manner.

Definition 3.1. Flow-rate maximal routing. Let [symbol] = [symbol] , [symbol] , {cₗ, ∀l ∈ [symbol] } [symbol] be a network and suppose that a new flow ƒ arrives. We will say that a routing algorithm is flow-rate maximal if it routes flow ƒ through a path that maximizes its transmission rate r_{ƒ}.

In traditional IP routing, all packets transmitted from a source to a destination node follow the same lowest-cost route. This rigidity leads to the well-known fish problem, whereby certain paths in a network become congested while other paths are underutilized. Various aspects of the flow-rate maximal algorithm, instead, are able to bypass points of congestion by assigning new flows to the highest-throughput path available given the current usage of the network.

One might mistakenly think that the least congested path can be identified by looking for links with small fair shares (Definition 2.3). However, the placement of a new flow onto a given path will itself alter the state of the network, changing those fair shares and potentially rendering the chosen path sub-optimal. In this section, we show that QTBS can be used to identify the maximal-rate path for a flow while taking into account the perturbations created by the placement of the flow itself, thus solving the flow-rate maximal routing problem.

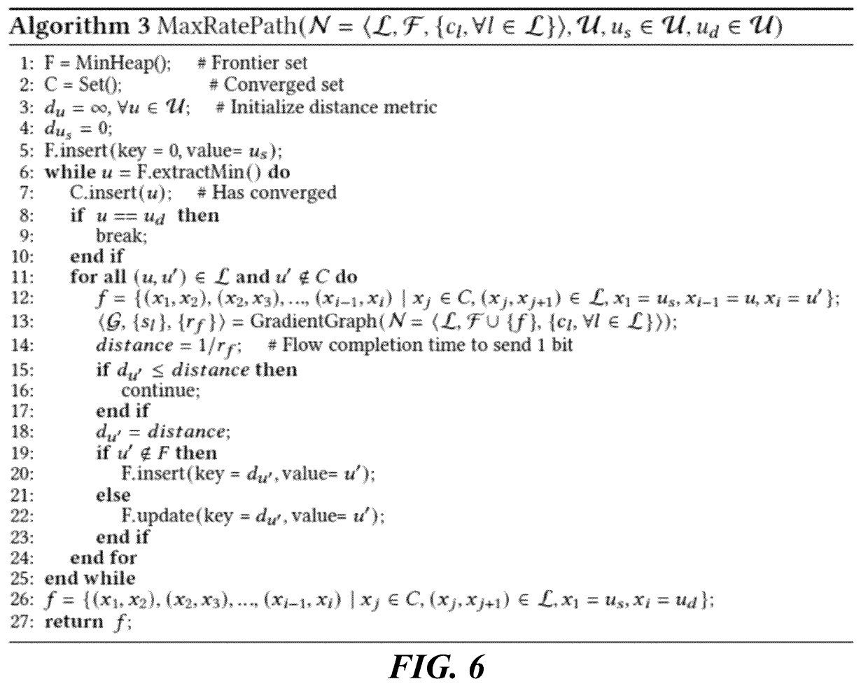

MaxRatePath( ) (Algorithm 3 shown in FIG. 6) is an algorithm that uses QTBS to compute flow-rate maximal paths. It takes the following inputs: a network [symbol] =( [symbol] , [symbol] , {cₗ, ∀l ∈ [symbol] } [symbol] , the set of routers [symbol] , and the source and the destination routers of the flow we intend to route, uₛ and u_{d}. By convention, a link l ∈ [symbol] is identified with the tuple l=(uₓ, u_{y}) where uₓ, u_{y} are the two routers connected by link l. The algorithm returns the new flow ƒ, expressed as the set of links it traverses, guaranteeing they form a path from uₛ to u_{d} that yields the maximal rate r_{ƒ} for ƒ.

As the pseudocode shows, MaxRatePath( ) is based on Dijkstra's shortest path algorithm, with routers as vertices and links as edges in the network topology graph. The difference resides in the way the “distance” to a neighboring router u′ is calculated (lines 12-14). In MaxRatePath( ) this value represents not the number of hops on the shortest path from uₛ to u′, but the inverse of the largest possible rate that a flow would experience if it were added on some path from uₛ to u′. That is, the distance to u′ is the smallest possible time needed to send 1 bit of information from us to u′.

Unlike in the standard Dijkstra's algorithm, this value cannot be computed by adding an edge length to dᵤ, the distance to a neighbor of u′. Instead, we create a new flow ƒ by extending the optimal path from uₛ to u. So, at each iteration of the algorithm, ƒ takes the path uₛ→ . . . →u→u′ (line 12). We then construct the gradient graph that would correspond to this network if the new flow ƒ were added (line 13). Finally, we use the inverse of the rate assigned to the new flow r_{ƒ} as the distance value (line 14). In the pseudocode, we invoke the GradientGraph( ) algorithm in line 13, reconstructing the gradient graph to include the new flow.

Lemma 3.2. Correctness of the MaxRatePath algorithm. Let [symbol] = [symbol] , [symbol] , {cₗ, ∀l ∈ [symbol] } [symbol] be a network and [symbol] the set of its routers. Suppose that ƒ and ƒ′ are two flows not in [symbol] that originate at router uₛ and end at router u_{d}. Then ƒ=MaxRatePath( [symbol] , [symbol] , uₛ, u_{d}) implies r_{ƒ}≥r_{ƒ}′.

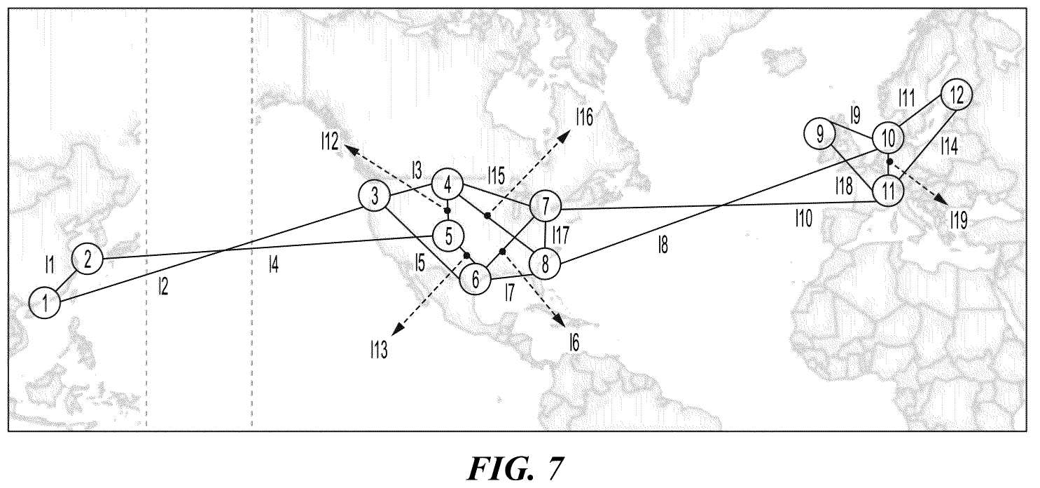

To illustrate how we can use QTBS and the MaxRatePath( ) algorithm to compute the highest-throughput path for a given flow, consider the network shown in FIG. 7. This topology corresponds to Google's B4 network, the SDN-WAN network that connects Google's data centers globally. For the sake of illustration, we will assume there are two flows (one for each direction) connecting every data center in the US with every data center in Europe, with all flows routed along a shortest path from source to destination. Since there are six data centers in the US and four in Europe, this configuration has a total of 48 flows (| [symbol] |=6×4×2). Table 1 shows the exact path followed by each flow. All links are assumed to have a capacity of 10 Gbps except for the transatlantic links, which are configured at 25 Gbps (e.g., cₗ=10, for all l ∉ (l₈, l₁₀), Cₗ_{₈}=cₗ_{₁₀}=25). While production networks operate with a much higher number of flows, in our example we use a reduced number to simplify the descriptions of the bottleneck structures and the steps followed to resolve the given problem. This simplification is without loss of generality, and the same approach is applicable to large scale operational networks.

TABLE 1
Path followed by each flow in the
routing optimization experiments

| Experiment 1: | | Experiment 2: | |
|---|---|---|---|
| | Links | | Links |
| Flow | Traversed | Flow | Traversed |
| f₁ | { [symbol] 3, [symbol] 15, [symbol] 10, | f₁ | { [symbol] 3, [symbol] 15, [symbol] 10, |
| | [symbol] 18} | | [symbol] 18} |
| f₂ | { [symbol] 5, [symbol] 7, [symbol] 8} | f₂ | { [symbol] 5, [symbol] 7, [symbol] 8 } |
| f₃ | { [symbol] 3, [symbol] 15, [symbol] 10} | f₃ | { [symbol] 3, [symbol] 15, [symbol] 10} |
| f₄ | { [symbol] 3, [symbol] 15, [symbol] 10, [symbol] 14} | f₄ | { [symbol] 3, [symbol] 15, [symbol] 10, [symbol] 14} |
| f₅ | { [symbol] 15, [symbol] 10, [symbol] 18} | f₅ | { [symbol] 15, [symbol] 10, [symbol] 18 } |
| f₆ | { [symbol] 16, [symbol] 8} | f₆ | { [symbol] 16, [symbol] 8} |
| f₇ | { [symbol] 15, [symbol] 10} | f₇ | { [symbol] 15, [symbol] 10} |
| f₈ | { [symbol] 15, [symbol] 10, [symbol] 14} | f₈ | { [symbol] 15, [symbol] 10, [symbol] 14} |
| f₉ | { [symbol] 13, [symbol] 6, [symbol] 10, | f₉ | { [symbol] 13, [symbol] 6, [symbol] 10, |
| | [symbol] 18} | | [symbol] 18} |
| f₁₀ | { [symbol] 13, [symbol] 7, [symbol] 8} | f₁₀ | { [symbol] 13, [symbol] 7, [symbol] 8} |
| f₁₁ | { [symbol] 13, [symbol] 6, [symbol] 10} | f₁₁ | { [symbol] 13, [symbol] 6, [symbol] 10} |
| f₁₂ | { [symbol] 13, [symbol] 6, [symbol] 10, | f₁₂ | { [symbol] 13, [symbol] 6, [symbol] 10, |
| | [symbol] 14} | | [symbol] 14} |
| f₁₃ | { [symbol] 7, [symbol] 8, [symbol] 9} | f₁₃ | { [symbol] 7, [symbol] 8, [symbol] 9} |
| f₁₄ | { [symbol] 7, [symbol] 8} | f₁₄ | { [symbol] 7, [symbol] 8} |
| f₁₅ | { [symbol] 7, [symbol] 8, [symbol] 9} | f₁₅ | { [symbol] 7, [symbol] 8, [symbol] 9} |
| f₁₆ | { [symbol] 7, [symbol] 8, [symbol] 11} | f₁₆ | { [symbol] 7, [symbol] 8, [symbol] 11} |
| f₁₇ | { [symbol] 10, [symbol] 18} | f₁₇ | { [symbol] 10, [symbol] 18} |
| f₁₈ | { [symbol] 10, [symbol] 19} | f₁₈ | { [symbol] 10, [symbol] 19} |
| f₁₉ | { [symbol] 10} | f₁₉ | { [symbol] 10} |
| f₂₀ | { [symbol] 10, [symbol] 14} | f₂₀ | { [symbol] 10, [symbol] 14} |
| f₂₁ | { [symbol] 8, [symbol] 9} | f₂₁ | { [symbol] 8, [symbol] 9} |
| f₂₂ | { [symbol] 8} | f₂₂ | { [symbol] 8} |
| f₂₃ | { [symbol] 8, [symbol] 19} | f₂₃ | { [symbol] 8, [symbol] 19} |
| f₂₄ | { [symbol] 8, [symbol] 11} | f₂₄ | { [symbol] 8, [symbol] 11} |
| f₂₅ | { [symbol] 15, [symbol] 10} | f₂₅ | { [symbol] 16, [symbol] 8, [symbol] 19, [symbol] 20} |

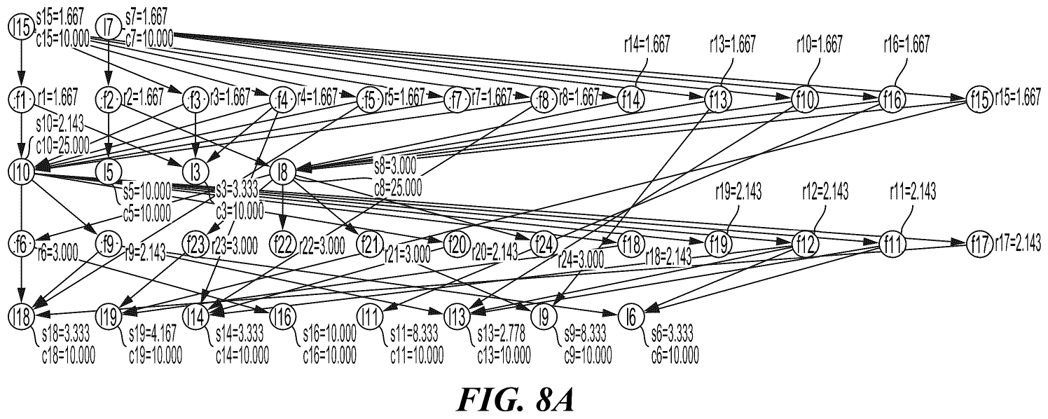

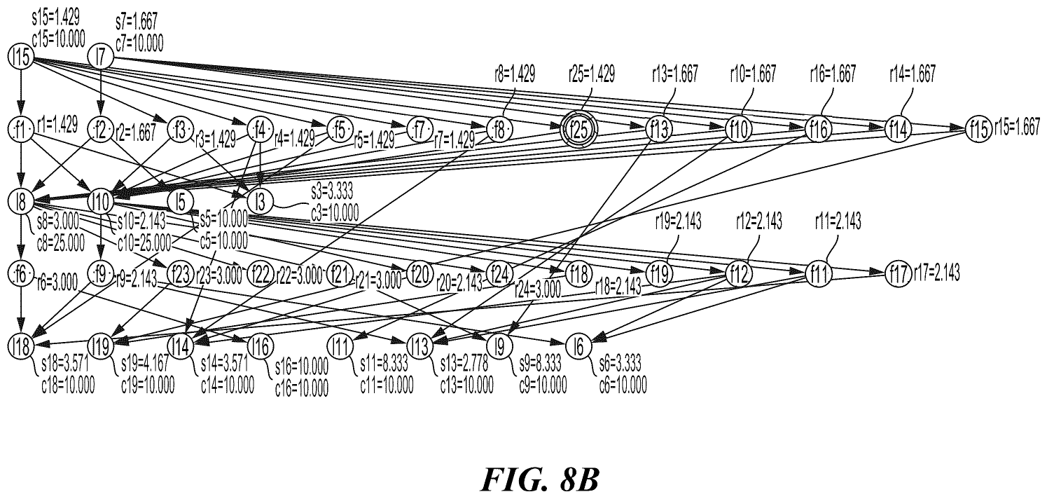

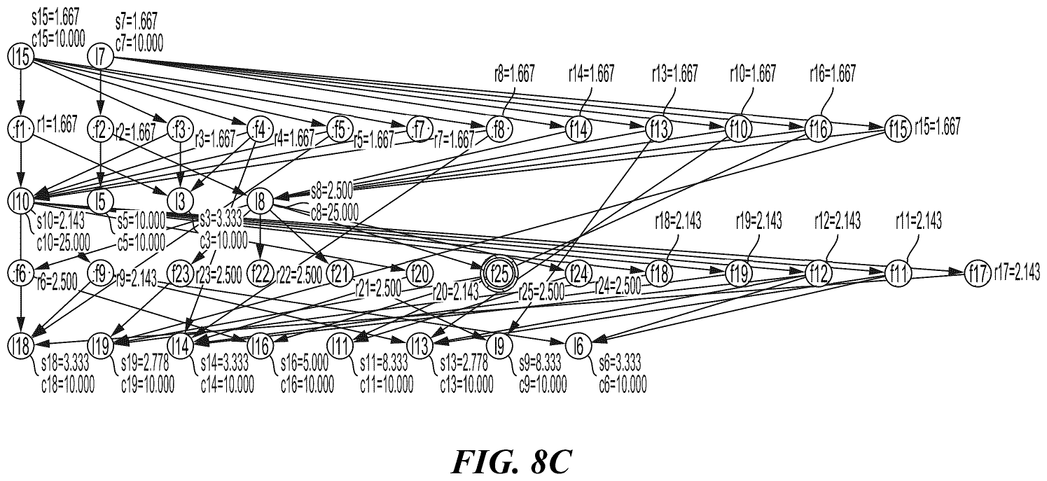

FIG. 8A shows the corresponding bottleneck structure obtained from running Algorithms 1A or 1B (FIGS. 3A-3B). This structure shows that flows are organized in two levels: the top-level includes flows {ƒ₁, ƒ₂, ƒ₃, ƒ₄, ƒ₅, ƒ₇, ƒ₈, ƒ₁₀, ƒ₁₃, ƒ₁₄, ƒ₁₅, ƒ₁₆} and the low-level includes flows {ƒ₆, ƒ₉, ƒ₁₁, ƒ₁₂, ƒ₁₇, ƒ₁₈, ƒ₁₉, ƒ₂₀, ƒ₂₁, ƒ₂₂, ƒ₂₃, ƒ₂₄}. Note that because each pair of data centers is connected via two flows (one for each direction), without loss of generality, in FIG. 8A we only include the first 24 flows (flows transferring data from US to Europe), since the results are symmetric for rest of the flows—e.g., flow ƒ₁ has the same theoretical transmission rate and is positioned at the same level in the bottleneck structure as flow ƒᵢ₊₂₄, for all 1≤i≤24.

Note also that all the top-level flows operate at a lower transmission rate (with all rates at 1.667) than the bottom-level flows (with rates between 2.143 and 3). This in general is a property of all bottleneck structures: flows operating at lower levels of the bottleneck structure have higher transmission rates than those operating at levels above. Under this configuration, suppose that we need to initiate a new flow ƒ₂₅ to transfer a large data set from data center 4 to data center 11. For instance, this flow could correspond to the transmission of a terabyte data set from a data center in the US to another in Europe. Our objective in this exercise is to identify a high-throughput route to minimize the time required to transfer the data.

Because the bottleneck structure reveals the expected transmission rate of a flow based on the path it traverses, we can use QTBS to resolve this problem. In FIG. 8B we show the bottleneck structure obtained for the case that ƒ₂₅ uses the shortest path l₁₅→l₁₀. For instance, this corresponds to the solution obtained from running BGP with a link cost metric equal to 1. Using this path, the new flow would be placed at the upper bottleneck level—e.g., the lower-throughput level-in the bottleneck structure, receiving a theoretical rate of r₂₅=1.429.

Note that the presence of this new flow slightly modifies the performance of some of the flows on the first level (flows {ƒ₁, ƒ₃, ƒ₄, fs, ƒ₇, ƒ₈} experience a rate reduction from 1.667 to 1.429), but it does not modify the performance of the flows operating at the bottom level. This is because, for the given configuration, the new flow only creates a shift in the distribution of bandwidth on the top level, but the total amount of bandwidth used in this level stays constant. (In FIG. 8A, the sum of all the flow rates on the top bottleneck level is 1.667×12=20, and in FIG. 8B this value is the same: 1.429×7+1.667×6=20.) As a result, the ripple effects produced from adding flow ƒ₂₅ into the network cancel each other out without propagating to the bottom level.

While (l₁₅→l₁₀ is the shortest path, it is not the path with the highest throughput. To find such a path, we run an aspect of the MaxRatePath procedure (Algorithm 3) and obtain the solution l₁₆→l₈→l₁₉. The resulting bottleneck structure is shown in FIG. 8C. Using this path, flow ƒ₂₅ would now be placed at the bottom level—the higher-throughput level—in the bottleneck structure, thus resulting in a rate value r₂₅=2.5, an increase of 74.95% with respect to the shortest path solution. Another positive outcome of this solution is that none of the flows operating at the upper level (the flows that receive less bandwidth) sees its rate reduced. This is a direct consequence of Theorem 2.5, since a perturbation on lower levels can have no ripple effects on upper levels. This represents a natural fairness property of aspects of the MaxRatePath algorithm: as the procedure assigns maximal-throughput paths to new incoming flows, such flows tend to be placed at the bottom of the bottleneck structure (where the high-throughput links are located), thus tending to create no negative impact on the lower-throughput flows located at the top of the structure.

In the remainder of this section, we set out to empirically confirm these results. We start by creating the B4 network configuration shown in FIG. 7 using Mininet-Extensions-Anonymized. Following our example, we deploy a total of 48 shortest-path flows connecting every pair of nodes (in both directions) between the US and Europe. We then add two extra flows labeled ƒ₂₅ and ƒ₅₀ (one for each direction) to connect data centers 4 and 11, and perform two separate experiments: one placing the flows on the shortest path l₁₅→l₁₀ and another one placing them on the longer path l₁₆→l₈→l₁₉.

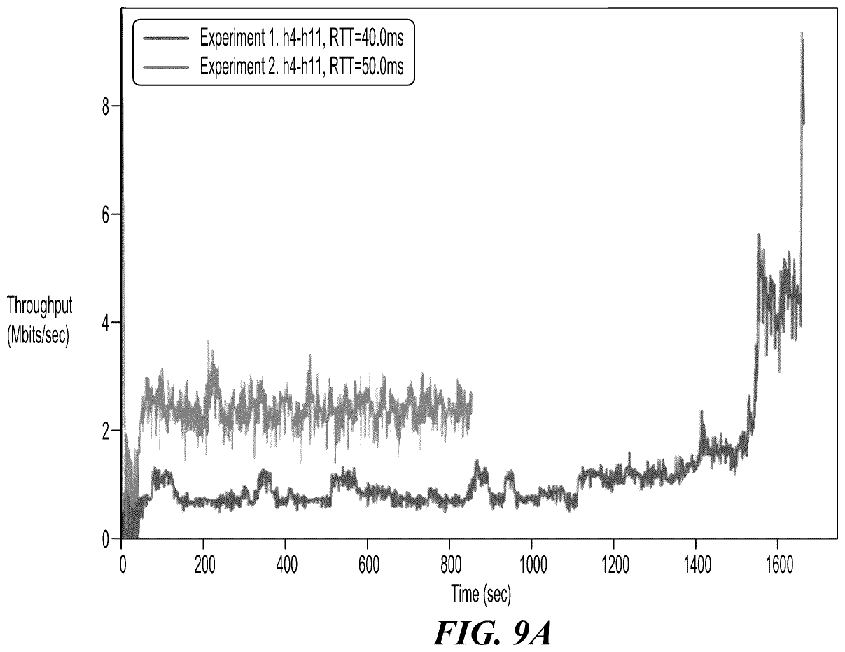

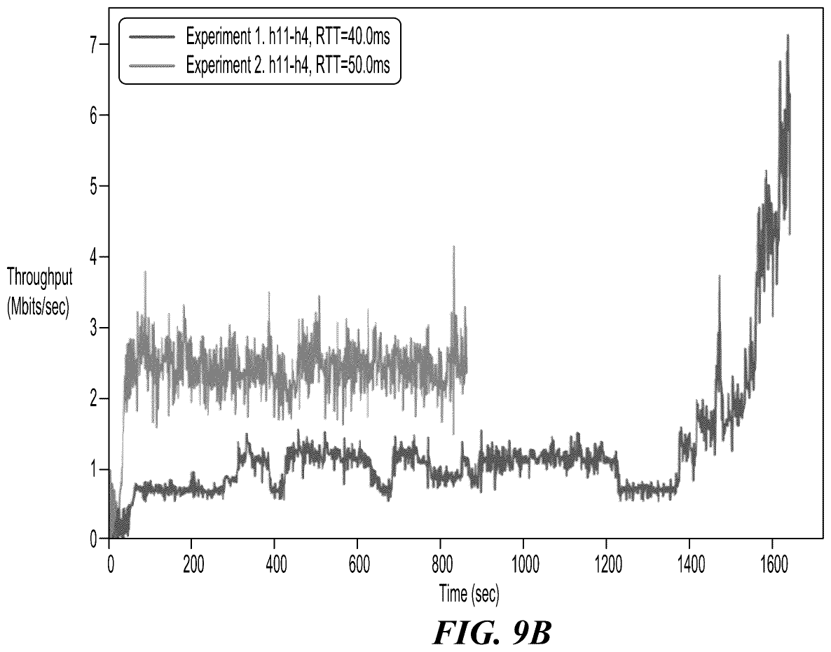

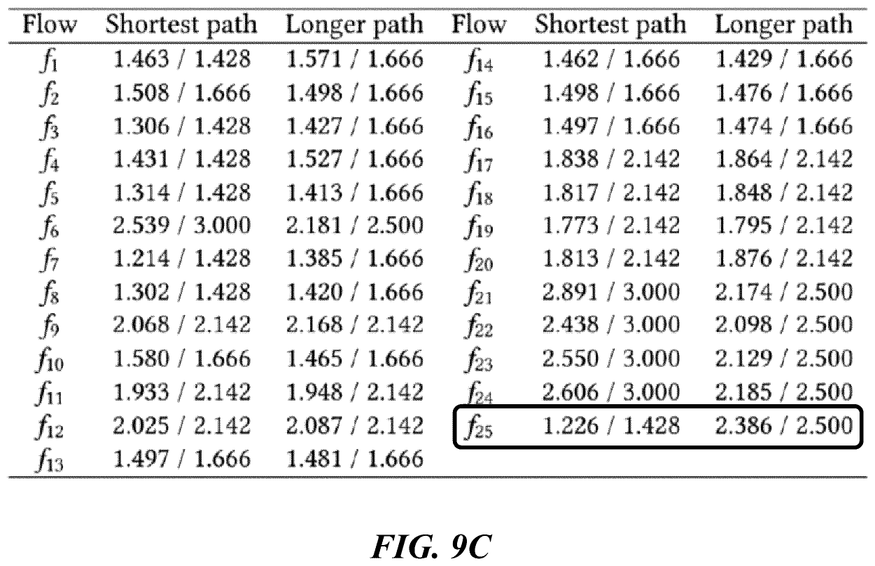

FIGS. 9A and 9B show the respective rates of flows ƒ₂₅ and ƒ₅₀, for the two experiments. In the legend of this plot, experiment 1 and 2 correspond to the shortest and the (longer) maximal-throughput path configurations, respectively. As predicted by the bottleneck structure, the longer path achieves a higher throughput and, thus, a lower flow completion time. The table shown in FIG. 9C presents the average throughput obtained for all twenty-five flows from the US to Europe and for each of the two experiments, alongside the theoretical values according to the bottleneck structure. The results obtained from the other twenty-five flows on the reverse path are similar. As shown, flow ƒ₂₅ achieves a performance of 1.226 and 2.386 Mbps for the shortest and longer paths, respectively—with the theoretical rates being 1.428 and 2.5 Mbps, respectively. Thus, the longer path yields a 94% improvement on flow throughput compared to the shortest path. For all the experiments run in this section, Jain's fairness index was above 0.99, indicating the accuracy of QTBS in predicting flow performance.

This experiment illustrates that using QTBS, it is possible to identify routes that are highly efficient from a congestion control standpoint. Note that this contrasts with traditional approaches that perform traffic engineering by separating the routing and congestion control problems, so that the routing algorithm is unaware of the choices made by the congestion control algorithm and vice versa. We reason that QTBS provides a mathematical framework to connect both problems, identifying routes that are globally efficient from both a topological and a congestion control standpoint.

The above-described technique is not limited to adding new flows to a network. An existing flow may be rerouted using the technique described above. If an existing flow is to be rerouted, the existing flow may be terminated and removed from the network topology. A few flows may then be added between the source and destination of the removed flow, as discussed above.

### 3.2 Capacity Planning: Design of Optimal Fat-Tree Networks in Data Centers

Fat-trees are generally understood as universally efficient networks in the following sense: for a given network size s, a fat-tree can emulate any other network that can be laid out in that size s with a performance slowdown at most logarithmic in s. This property makes fat-tree topologies highly competitive and is one of the reasons they are so widely used in large-scale data centers and high-performance computing (HPC) networks. In the context of data centers, fat-tree networks are also known as folded-clos or spine-and-leaf networks. In this experiment, we use QTBS to demonstrate that, due to the effects of the congestion control algorithm, there exists an optimal trade-off in the allocation of capacity at the top levels of the fat-tree. Further. we show that the optimal bandwidth allocation on the top level deviates from commonly accepted best practices in the design of full fat-tree networks that tend to equate the amount of bandwidth going up and down the tree at each switch.

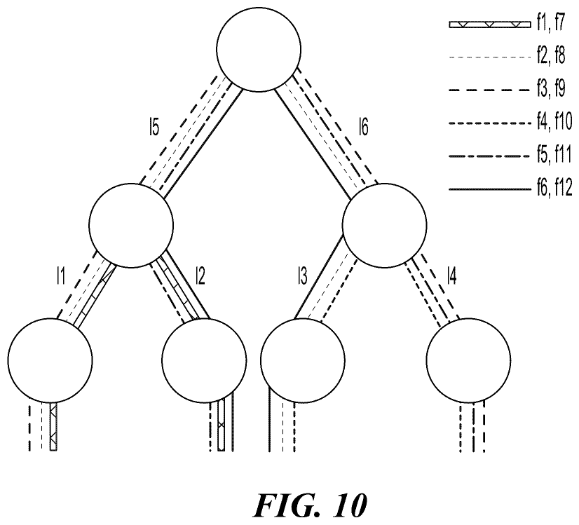

Consider the network topology in FIG. 10, which corresponds to a binary fat-tree with three levels and six links ( [symbol] ={l₁, l₂, . . . , l₆}). Assume also that there are two flows (one for each direction) connecting every pair of leaves in the fat-tree network, providing bidirectional full-mesh connectivity among the leaves. Since there are four leaves, that results in a total of 4×3=12 flows. All of the flows are routed following the shortest path, as shown in Table 2 below. For the sake of convention, we adopt the terminology from data center architectures and use the names spine and leaf links to refer to the upper and lower links of the fat-tree network, respectively.

TABLE 2
Path followed by each flow in the fat-tree networks experiments

| | Experiment 1, 2, 3: Links |
|---|---|
| Flow | Traversed |
| f₁ | { [symbol] 1, [symbol] 2} |
| f₂ | { [symbol] 1, [symbol] 5, [symbol] 6, [symbol] 3} |
| f₃ | { [symbol] 1, [symbol] 5, [symbol] 6, [symbol] 4} |
| f₄ | { [symbol] 2, [symbol] 1} |
| f₅ | { [symbol] 2, [symbol] 5, [symbol] 6, [symbol] 3} |
| f₆ | { [symbol] 2, [symbol] 5, [symbol] 6, [symbol] 4 } |
| f₈ | { [symbol] 3, [symbol] 6, [symbol] 5, [symbol] 2} |
| f₉ | { [symbol] 3, [symbol] 4} |
| f₁₀ | { [symbol] 4, [symbol] 6, [symbol] 5, [symbol] 1} |
| f₁₁ | { [symbol] 4, [symbol] 6, [symbol] 5, [symbol] 2} |
| f₁₂ | { [symbol] 4, [symbol] 3} |

We fix the capacity of the leaf links to a value λ (e.g., cₗ_{₁}=cₗ_{₂}=cₗ_{₃}=cₗ_{₄}=λ) and the capacity of the spine links to λ×τ(e.g., cₗ_{₅}=cₗ_{₆}=λ×τ), where τ is used as a design parameter enabling a variety of network configurations. For instance, in our binary fat-tree example, the case τ=2λ corresponds to a full fat-tree network, because the total aggregate bandwidth at each level of the tree is constant, cₗ_{₁}+cₗ_{₂}+cₗ_{₃}+cₗ_{₄}=cₗ_{₅}+cₗ_{₆}=4λ. Similarly, the case τ=1 corresponds to a thin-tree network, since it results with all the links having the same capacity, c₁_{ᵢ}=λ, for all 1≤i≤6. The conventional technique of optimizing the performance-cost trade-off of a fat-tree network by adjusting the capacity of the spine links is sometimes referred as bandwidth tapering.

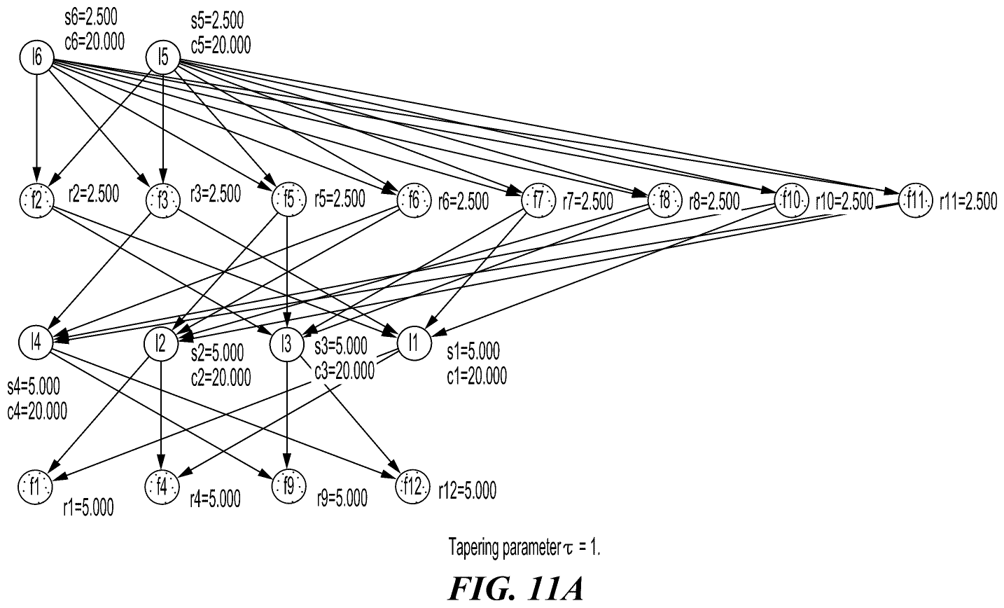

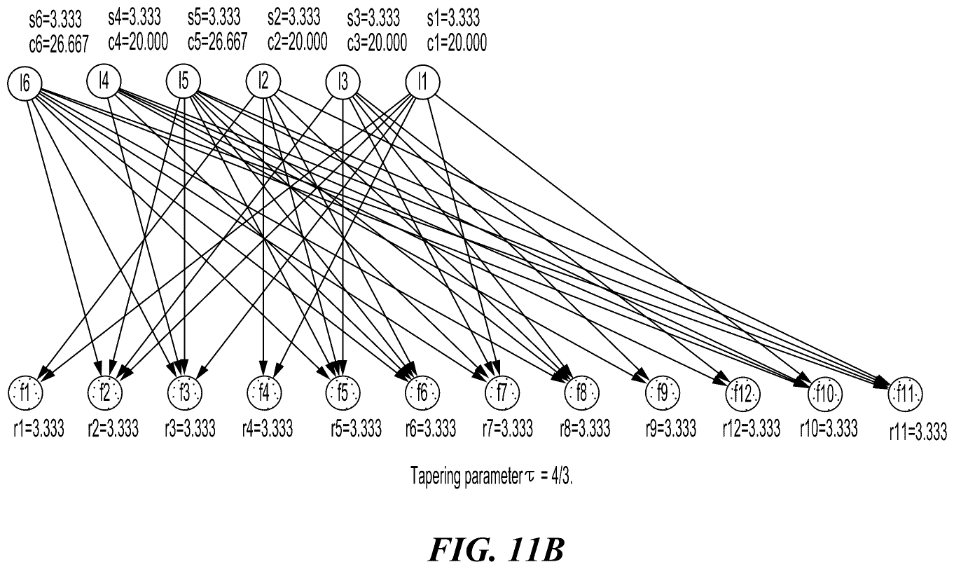

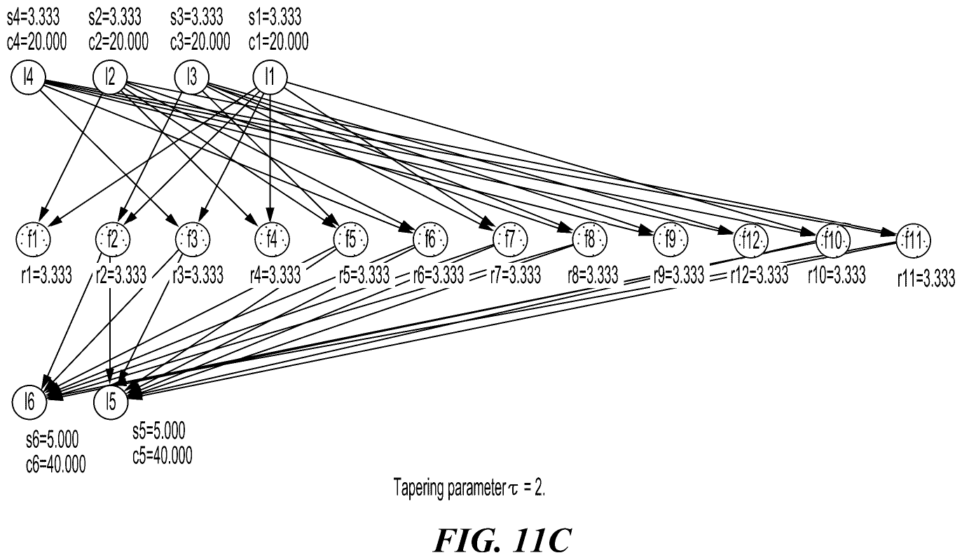

The focus of our experiment is to use the bottleneck structure analysis to identify optimized choices for the tapering parameter τ. In FIGS. 11A-11C, we present sequences of bottleneck structures (e.g., obtained from running Algorithm 1B (FIG. 3B) corresponding to our fat-tree network with three different values of the tapering parameter τ and fixing λ=20. Note that the fixing of A to this value is without loss of generality, as the following analysis applies to any arbitrary value λ>0.

The first bottleneck structure (FIG. 11A) corresponds to the case τ=1 (e.g., all links have the same capacity, cₗ_{ᵢ}=20, for all 1≤i≤6). This solution leads to a bottleneck structure with flows confined in one of two possible levels: a top level, where flows perform at a lower rate, r_{ƒ}_{₂}=r_{ƒ}_{₃}=r_{ƒ}_{₅}=r_{ƒ}_{₆}=r_{ƒ}_{₇}=r_{ƒ}_{₈}=r_{ƒ}_{₁₀}=r_{ƒ}_{₁₁}=2.5; and a bottom level, where flows perform at twice the rate of the top-level flows, r_{ƒ}_{₁}=r_{ƒ}_{₄}=r_{ƒ}_{₉}=r_{ƒ}_{₁₂}=5. This configuration is thus unfair to those flows operating at the top bottleneck, which receive half the bandwidth of the flows at the bottom level. Furthermore, this configuration is also inefficient at supporting applications with symmetric workload patterns—where all nodes approximately send the same number of bytes to each other—because the completion time of the slowest flows is significantly higher (twice as high since they get half the rate) than the faster flows. Let us next consider how we can use QTBS to identify a value of τ that minimizes the maximum completion time of any of the flows under the assumption of symmetric workloads.

By looking at the bottleneck structure in FIG. 11B, we know that the slowest flows are confined in the top bottleneck level. In order to increase the rates of these flows, we need to increase the tapering parameter τ that controls the capacity of the spine links l₅ and l₆. Such action transforms the bottleneck structure by bringing the two levels closer to each other, until they fold. We can obtain the collision point by computing the link gradients and their leap and fold as follows. The link gradient of any of the spine links with respect to any of the top-level flows is ∇ₗ(ƒ)=0.125, for all l ∈ {l₅, l_{6}} and ƒ ∈ {ƒ₂, ƒ₃, ƒ₅, ƒ₆, ƒ₇, ƒ₈, ƒ₁₀, ƒ₁₁}.

On the other hand, the link gradient of any of the spine links with respect to any of the low-level flows is ∇ₗ(ƒ)=−0.25, for all l ∈ {l₅, l₆} and ƒ ∈ {ƒ₁, ƒ₄, ƒ₉, ƒ₁₂}. That is, an increase by one unit on the capacity of the spine links increases the rate of the top-level flows by 0.125 and decreases the rate of the low-level flows by 0.25. Since the rates of the top and low-level flows are 2.5 and 5, respectively, this means that the two levels will fold at a point where the tapering parameter satisfies the equation 2.5+0.125·τ·λ=5−0.25·τ·λ, resulting in

$$τ = \frac{4}{3}$$

and, thus, cₗ_{₅}=cₗ_{₆}=26.667.

Note that this value corresponds exactly to the leap of the spine links gradient, and thus can also be programmatically obtained using Algorithm 2 (FIG. 3C). The resulting bottleneck structure for this configuration is shown in FIG. 11B, confirming the folding of the two levels. This fat-tree configuration is optimal in that the flow completion time of the slowest flow is minimal. Because the bottleneck structure is folded into a single level, this configuration also ensures that all flows perform at the same rate, r_{ƒ}_{ᵢ}=3.333, for all 1≤i≤6.

What is the effect of increasing the tapering parameter above

$$\frac{4}{3} ?$$

This result is shown in FIG. 11C for the value of τ=2, e.g., cₗ_{₅}=cₗ_{₆}=40. In this case, the two-spine links are no longer bottlenecks to any of the flows (since these links are leaves in the bottleneck structure), but all flows continue to perform at the same rate, r_{ƒ}_{ᵢ}=3.333, for all 1≤i≤6. Thus, increasing the capacity of the upper-level links does not yield any benefit, but increases the cost of the network. This result indicates that the fat-tree network shown in FIG. 10 should not be designed with an allocation of capacity on the spine links higher than

$$τ = \frac{4}{3}$$

times the capacity of the leaf links.

In summary, for the fat-tree network shown in FIG. 10 we have:
A tapering parameter

$$τ \geq \frac{4}{3}$$

should not be used, since the resulting network is just as efficient as a design with

$$τ = \frac{4}{3} ,$$

but more costly.
A tapering parameter

$$τ = \frac{4}{3}$$

is optimal in that it minimizes the flow completion time of the slowest flow. This should be the preferred design in symmetric workloads that transfer about the same amount of data between any two nodes.
A tapering parameter

$$τ < \frac{4}{3}$$

can be used it workloads are asymmetric, identifying the right value of τ that produces the right amount of bandwidth at each level of the bottleneck structure according to the workload.

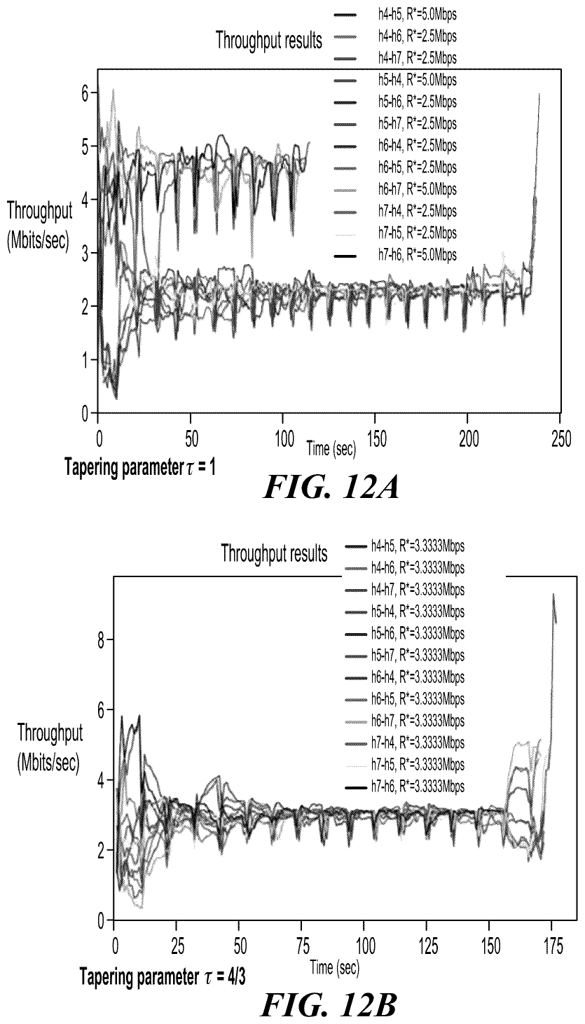

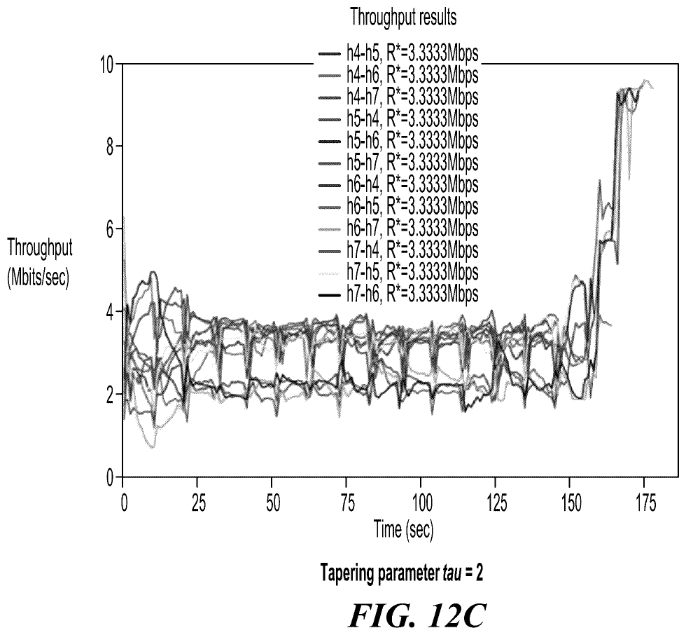

In the rest of this section, we empirically demonstrate the existence of an optimal fat-tree design at τ=4/3 using Mininet-Extensions-Anonymized configured with the congestion control algorithm BBR. FIGS. 12A-12C present the results of the experiments for the three values of the tapering parameter,

$$τ ∈ \{ 1 , \frac{4}{3} , 2 \} .$$

Each plot shows the transmission rate of all twelve flows as part of the network configuration, with each flow transmitting a total of 64 MB of data. Following the example in Section 3.2.1, the link capacities are set as follows: cₗ_{₁}=cₗ_{₂}=cₗ_{₃}=cₗ_{₁}=λ=20 Mbps and cₗ_{₅}=ₗ_{₆}=λ×τ=20×τ Mbps.

TABLE 3
Flow completion times (seconds) of the fat-tree experiments

| Flow | τ = 1 | τ = 4/3 | τ = 2 |
|---|---|---|---|
| f₁ | 115 | 172 | 175 |
| f₂ | 237 | 171 | 164 |
| f₃ | 239 | 177 | 156 |
| f₄ | 111 | 172 | 173 |
| f₅ | 236 | 167 | 158 |
| f₆ | 223 | 172 | 147 |
| f₇ | 223 | 152 | 144 |
| f₈ | 212 | 170 | 143 |
| f₉ | 112 | 171 | 178 |
| f₁₀ | 201 | 173 | 153 |
| f₁₁ | 226 | 174 | 154 |
| f₁₂ | 113 | 155 | 173 |
| Max ( ) | 239 | 177 | 178 |

As predicated by QTBS, the case τ=1 has flows operating at one of two bottleneck levels, close to the rates predicted by the bottleneck structure (2.5 Mbps for the upper-level flows and 5 Mbps for the lower-level flows, see FIG. 11A). This fat-tree design is inefficient for symmetric workloads since the flow completion time of the slowest flow is not minimal. Under this configuration, flow ƒ₃ is the slowest flow and its completion time is 239 seconds. (See Table 3 for all flow completion time values).

If we want to maximize the rate of the slowest flow, QTBS tells us that the right tapering parameter value is 4/3. This case is presented in FIG. 12B, which indeed shows how all flows perform at a very similar rate close to the theoretical value of 3.333 Mbps (see FIG. 11B). This configuration is optimal in that it minimizes the maximum completion time of any of the flows. In this experiment, the completion time of the slowest flow is 177 seconds, an improvement of 25.9% with respect to the case of τ=1.

FIG. 12C shows the results for the case of a full fat-tree network, τ=2. Once again, as predicted by QTBS, this solution achieves about the same completion time as the case τ=4/3 (the slowest flow completes in 178 seconds), since in this configuration the leaf links become the bottlenecks and the extra bandwidth added in the spine links does not produce any net benefit, as shown by the bottleneck structure in FIG. 11C. In summary, as predicted by QTBS, the case τ=4/3 generally represents an optimal design in that it is the least costly network that minimizes the maximum completion time of any of the flows.

Note that the existence of an optimal design with a tapering parameter τ=4/3 argues against some of the established conventional best practices in fat-tree networks. For instance, while a full fat-tree (τ=2) is considered generally to be universally efficient, the analysis of its bottleneck structure demonstrates that such design is in general inefficient when flows are regulated by a congestion-control protocol. This is because the fairness and throughput maximization objectives targeted by the congestion control algorithm effectively bends the solution space and, as a result, the optimal fat-tree design deviates from the general full fat-tree configuration. This result has implications in the design of data centers that use fat-tree topologies (also known as folded-Clos). In this section, we have illustrated how QTBS can be used to optimize a simple fat-tree topology for the case of a symmetric workload pattern.

### 3.3 Traffic Engineering: Accelerating Time-Bound Constrained Flows

Suppose that our goal is to accelerate a flow ƒₛ ∈F in a network [symbol] with the objective that such flow is completed before a certain time-bound requirement or a target time. A common application for the optimization of time-bound constrained flows can be found in research and education networks, where users need to globally share data obtained from their experiments, often involving terabytes or more of information—e.g., when scientists at the European Organization for Nuclear Research (CERN) need to share data with other scientific sites around the world using the Large Hadron Collider Open Network Environment (LHCONE) network. Another common use case can be found in large scale data centers, where massive data backups need to be transferred between sites to ensure redundancy. In this context, suppose the operators are only allowed to sacrifice the performance of a subset of flows [symbol] ′⊂ [symbol] {ƒₛ}, considered of lower priority than ƒₛ. What flows in [symbol] ′ present an optimal choice to traffic shape so as to accelerate ƒₛ? By what amount should the rate of such flows be reduced? And by what amount will flow ƒₛ be accelerated?

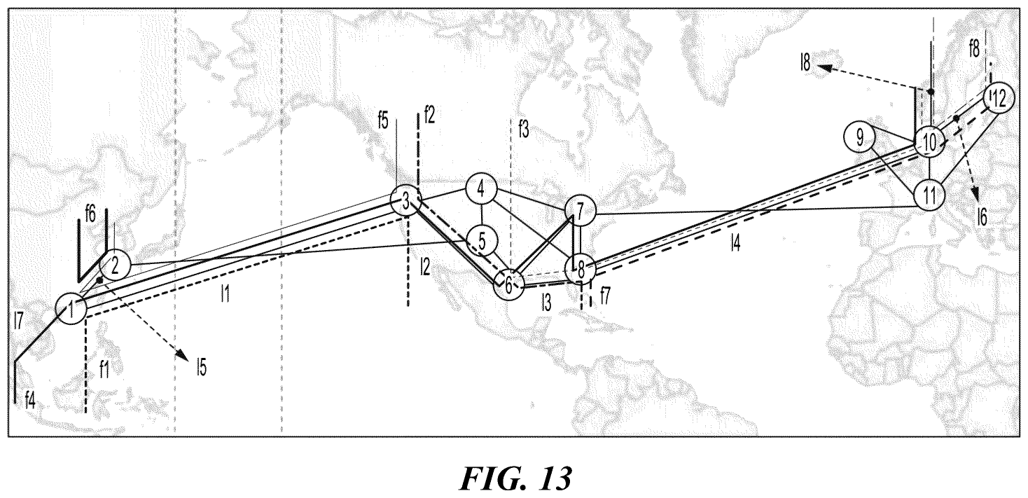

To illustrate that we can use QTBS to resolve this class of problems, consider the network shown in FIG. 7 and introduced in Section 3.1. This topology generally corresponds to Google's B4 network. In this experiment, assume there are eight flows. F={ƒ₁, ƒ₂, . . . , ƒ₈}, routed as shown in FIG. 13. While real-life networks usually operate with a much higher number of flows, in our example we use a reduced number merely to simplify the descriptions of the bottleneck structures and the steps followed to resolve the given problem. This is without loss of generality as we can apply the same procedure to optimize networks with arbitrary number of flows and topology. We will use the network's bottleneck structure to identify an optimal strategy for accelerating an arbitrary flow in a network. Assume that our objective is to accelerate flow ƒ₇ (e.g., ƒₛ=ƒ₇) in FIG. 13—the transatlantic flow that connects data centers 8 and 12—to meet a certain flow completion time constraint. Assume also that in order to maximize the performance of ƒ₇ we are allowed to traffic shape any of the flows in the set [symbol] ′=ƒ₁, ƒ₃, ƒ₄, ƒ₈. In other words, the set of flows in [symbol] ′ are considered by the network operator to be of lower priority.

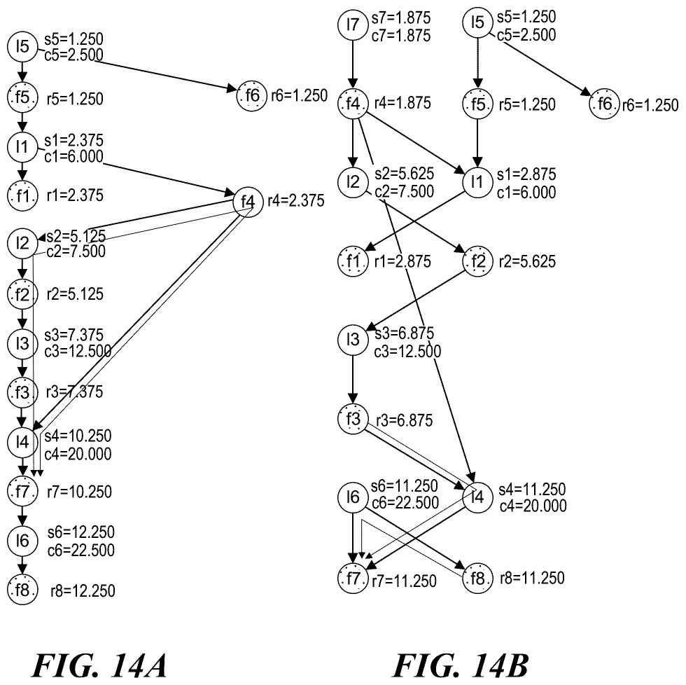

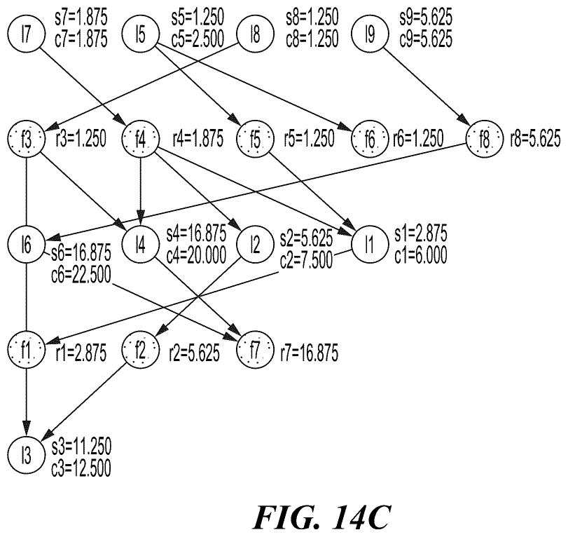

FIG. 13 displays the sequence of gradient graphs that lead to the acceleration of flow ƒ₇ to meet its time constraint. The graphs include the values of the capacity cₗ and fair share sₗ next to each link vertex l and the rate r_{ƒ} next to each flow vertex ƒ. FIG. 14A corresponds to the gradient graph of the initial network configuration shown in FIG. 13 as computed by Algorithm 1. From Theorem 2.5, we know that only the flows that are ancestors to ƒ₇ can have an effect on its performance. That means we can discard traffic shaping flow ƒ₈ as that will have no impact. We can use the ForwardGrad( ) algorithm (Algorithm 2) to obtain the gradients of flow ƒ₇ with respect to the flows in the low priority set [symbol] ′: ∇_{ƒ}_{₁}(ƒ₇)=−2, ∇_{ƒ}_{₂}(ƒ₇)=−1, ∇_{ƒ}_{₃}(ƒ₇)=1, ∇_{ƒ}_{₄}(ƒ₇)=2, ∇_{ƒ}_{₅}(ƒ₇)=−1, ∇_{ƒ}_{₆}(ƒ₇)=1, ∇_{ƒ}_{₈}(ƒ₇)=0.

We are interested in finding the gradient of a flow in F that has the highest negative value, so that the traffic shaping of such a flow (e.g., the reduction of its rate) creates a maximal positive increase in the rate of ƒ₂. We have that flow ƒ₄ has the highest negative gradient with a value of −2, yielding an optimal traffic shaping decision. From FIG. 14A, it can be observed that the reduction of flow ƒ₄'s rate creates a perturbation that propagates through the bottleneck structure via two different paths: ƒ₄→l₂→ƒ₂→l₃→ƒ₃→l₄→ƒ₇ and ƒ₄→l₄→ƒ₇. Each of these paths has an equal contribution to the gradient of value 1, resulting in ∇_{ƒ}_{₄}(ƒ₇)=2. Note that since this value is larger than 1, it is understood to be a power gradient (Definition 2.10).

We can use the bottleneck structure again to calculate the exact value of the traffic shaper—e.g., the rate reduction applied to flow ƒ₄. The core idea is that traffic shaping flow ƒ₄ may be an optimal decision as long as the bottleneck structure does not change, since a change in the structure would also imply a change in the gradients. As the rate of flow ƒ₄ is reduced, some levels in the bottleneck structure will become further away from each other, while the others will become closer to each other. Thus, the latter set will fold if the rate reduction imposed by the traffic shaper is large enough. The speed at which two links in the bottleneck structure get closer to (or further away from) each other is given by their gradients. In particular, if the traffic shaper reduces the rate of flow ƒ₄ by an amount of ρ bps, then two links l and l′ in the bottleneck structure will collide at a value of ρ that satisfies the equation sₗ−ρ·∇_{ƒ}_{₄}(l)=s_{l′}−ρ·∇_{ƒ}_{₄}(l′).

From the bottleneck structure (FIG. 14A) we can obtain the fair share values sₗ and using the ForwardGrad( )algorithm we can compute the link gradients ∇_{ƒ}_{₄}(l): sₗ_{₂}=5.125; sₗ_{₃}=7.375; sₗ_{₄}=10.25; sₗ_{₆}=12.25; ∇_{ƒ}_{₄}(l₂)=−1; ∇_{ƒ}_{₄}(l₃)=1; ∇_{ƒ}_{₄}(l₄)=−2; ∇_{ƒ}_{₄}(l₆)=2. Using these values, we have that the smallest value of ρ that satisfies the collision equation corresponds to the case l=l₄ and l′=l₆, yielding a ρ value of 0.5 (since 10.25−ρ·(−2)=12.25−ρ·2⇒ρ=0.5).

Thus, we conclude that to maximally increase the rate of flow ƒ₇, an optimal strategy is to decrease the rate of flow ƒ₄ by an amount of 0.5 units of bandwidth. The resulting bottleneck structure is presented in FIG. 14B, where a new link l₇ has been added that corresponds to the new traffic shaper set to reduce the rate of flow ƒ₄ by an amount of 0.5 (from 2.375 down to 1.875). Note that as expected, in this new bottleneck structure links l₄ and l₆ are folded into the same level and have the same fair share: S₄=S₆=11.25. Since ƒ₇ has now two bottleneck links (l₄ and l₆), we cannot accelerate it further unless we increase the fair-shares of both. Using the new bottleneck structure (FIG. 14B), it can be seen that this can be achieved by decreasing the rate of flows ƒ3 and ƒ₈, since the resulting link gradients are each negative ∇_{ƒ}_{₃}(l₄)=∇_{ƒ}_{₈}(l₆)=−1.

Therefore, we add two new traffic shapers l₈ and l₉ to throttle the rate of flows ƒ₃ and ƒ₈, respectively, down from their current rates of 6.875 and 11.25. That is: cₗ_{₈}=6.875−ρ and cₗ_{₉}=11.25−ρ, for some traffic shaping amount ρ. In FIG. 14C, we show the resulting bottleneck structure when choosing a value of ρ=5.625 (so cₗ_{₈}=1.25 and cₗ_{₉}=5.625), which further accelerates the rate of flow ƒ₇ to r₇=Sₗ_{₄}−ρ·∇_{ƒ}_{₃}(l₄)=sₗ_{₆}−ρ·∇_{ƒ}_{₈}(l₆)=11.25−5.625·(−1)=16.875. Note that there is some flexibility in choosing the value of this parameter, depending on the amount of acceleration required on flow ƒ₇. In this case, we chose a value that maximally accelerates flow ƒ₇ while ensuring none of the flows that are traffic shaped receives a rate lower than any other flow. With this configuration, flow ƒ₃'s rate is reduced to the lowest transmission rate among all flows in the network, but this value is no lower than the rate of flows ƒ₅ and ƒ₆ (r_{ƒ}_{₃}=r_{ƒ}_{₅}=r_{ƒ}_{₆}=1.25). Thus, the flow completion time of the slowest flow is preserved throughout the transformations performed in this example. This strategy also allows preserving or maintaining the relative order of links according to their respective fair shares.

In summary, a strategy to accelerate the performance of flow ƒ₇ includes traffic shaping the rates of flows ƒ₃, ƒ₄ and ƒ₈ down to 1.25, 1.875, and 5.625, respectively. Such a configuration results in a theoretical increase to the rate of flow ƒ₇ from 10.25 to 16.875, while ensuring no flow performs at a rate lower than the slowest flow in the initial network configuration. Note that among all the low priority flows in [symbol] ′, in the above process we opted for not reducing the rate of flow ƒ₁. Indeed, the three bottleneck structures (FIGS. 14A-14C) computed by this algorithm tell us that choosing to reduce the rate of flow ƒ₁ would in fact have either a negative effect or no effect at all on the rate of flow ƒ₇, since the gradients ∇_{ƒ}_{₁}(ƒ₇) for each structure are 2, 0, and 1, respectively. In other words, a reduction on the rate of flow ƒ₁ produces a non-positive impact on the rate of flow ƒ₇ in all cases.

Thus, the quantitative analysis resulting from the bottleneck structure of the network reveals not only the set of flows that should be traffic shaped, but also the flows that should not be traffic shaped, as doing so would actually hurt the performance of the flow we intend to accelerate. Note that this result challenges some of the established best practices for traffic engineering flows, which include many proposed algorithms that focus on reducing the rate of the heavy-hitter flows to improve highpriority flows. As shown in this example, without taking into account the bottleneck structure of a network, such algorithms may recommend a traffic shaping configuration that actually has the opposite of the intended effect.

### 6 Conclusions

The analytical strength of a bottleneck structure stems from its ability to capture the solution-space produced by a congestion-control algorithm taking into account the topological and routing constraints of the network. Based on this concept, we develop a quantitative theory of bottleneck structures (QTBS), a new mathematical framework that allows to optimize congestion-controlled networks by providing very efficient algorithms to compute derivatives on the performance parameters of links and flows. To explore the analytical power of QTBS, we use it to reveal insights in traffic engineering and network design problems that are themselves contributions to the literature. In one experiment, we use QTBS to develop a novel routing algorithm that identifies maximal throughput paths, enabling a scalable methodology to jointly solve the problems of routing and congestion control. In another experiment, we use QTBS to reveal the existence of optimal capacity allocations in the spine links of a fat-tree network that outperform (in cost and/or performance) the traditional full fat-tree network designs found in some large-scale data centers and supercomputers. In a third experiment, we demonstrate how to use bottleneck structures to compute the numerical values of optimal rate settings in traffic shapers to help improve the performance of high-priority flows. We present the concept of bottleneck structures as a promising analytical framework to optimize network performance. In general, this technique can be applied to any system that can be modeled as a network.

The overall network analysis and/or manipulation or control processes described herein begin with the collection of network information including flow information, link information, and topology. The flow information generally includes the identities of flow, the total count of flows, and the rates of the identified flows during a specified observation window, which can be a few minutes, a few hours, a few days, or longer. The link information includes the number of active links, their identities, and their designated and/or maximum capacities during the specified observation window. The network topology includes the network nodes and the links, typically direct links, interconnecting such nodes.

In case of data networks, the nodes may be data centers and/or computing centers, the links include data links, whether cable, wireless, or satellite based, the flow rates may include number of bits, bytes, packets, etc., passing through the links, and link capacities may be expressed in terms of available or allotted bandwidth or bit rate. In case of transportation networks, the nodes can be cities, locations within cities or a metropolitan area, airports, marine ports, etc., the links can be roadways, railways, subway routes, airline routes, marine routes, etc., the flow rates and link capacities can be expressed in terms of the number of passengers or travelers, the number of vehicles, etc.

In case of energy networks, the nodes can be energy generators such as power plants and consumers, such as towns, cities, industrial complexes, shopping centers, etc. The links include energy delivery systems including high-voltage transmission lines, substations, local energy distribution lines, etc. The flow rates and link capacity can be expressed in terms of peak energy demand, average energy demand, etc.

In case of fluidic or biological networks, the nodes can be sources and consumers of material, such as oil, gas, nutrients, blood, etc., and the link capacity can be the sizes of conduits or vessels carrying the fluids or biological materials, the pressure in such conduits or vessels, etc. In some cases, the capacity and/or rate of flow in one or more conduits/vessels can be adjusted by shutting off or pruning other conduits/vessels. The flow rate optimization and/or capacity planning can thus be used to manage or control irrigation systems, fertilizer delivery system, plant/crop disease control systems, etc.

After collecting the required information, the GradientGraph that includes various flow and link gradients is generated using aspects of Algorithms 1A or 1B (FIGS. 3A or 3B). The derivation of the GradientGraph may include efficient memory allocation, as described above in Section 3. For one or more links and/or flows of interest the respective leaps and folds are then computed using aspects of Algorithm 2 (FIG. 3C). Using the leaps and folds, one or more flows and/or one or more links may be selected for traffic shaping, e.g., for an adjustment to a property of the selected flow(s) or link(s). In particular, the rate of a flow may be decreased up to a corresponding leap and/or the allotted capacity of a link may be increased or decreased. It should be noted that the allotted capacity of link cannot exceed the physical capacity of the link.

The effect of this perturbation can be observed on the flow(s) and/or link(s) of interest, and the process may be repeated a specified number of times, until a desired effect (e.g., increase in the rate of a flow of interest) is attained, or a maximum feasible change can be attained. Such iterations may be performed under constraints, such as not permitting the flow rate of any flow below the current minimum or a specified lower-bound rate, maintaining the relative order of the flow rates, allotting at least a specified lower-bound capacity to each link, etc.

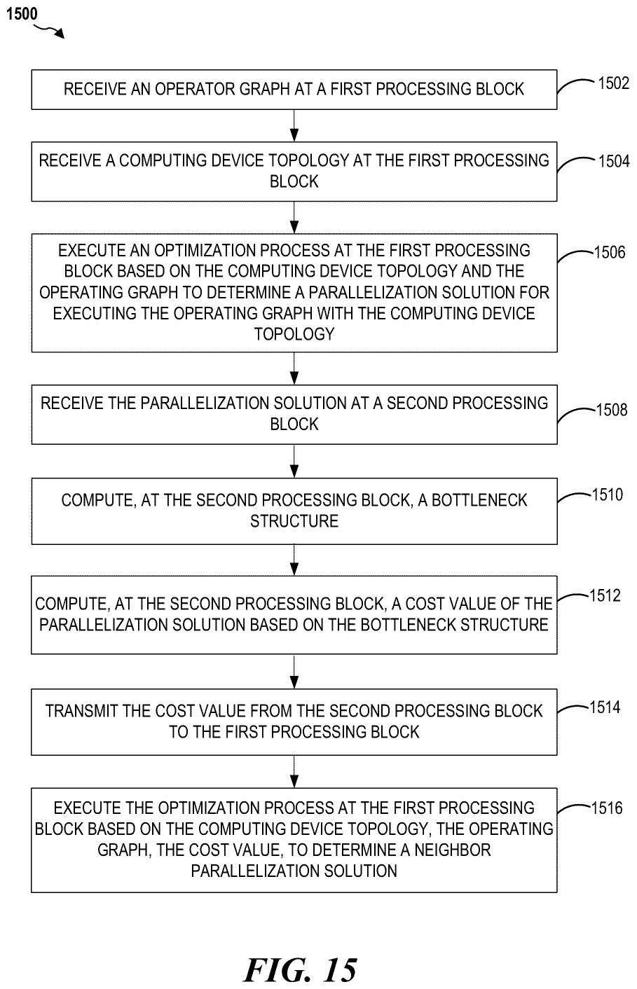

FIG. 15 illustrates a process 1500 for parallelizing an operator graph, in accordance with various aspects of the present disclosure. As shown in FIG. 15, in some aspects, the process 1500 may receive an operator graph at a first processing block (block 1502). The process 1500 may receive a computing device topology at the first processing block (block 1504). The computing device topology may be a multicore processor, a system-on-chip, and/or a network of computing devices. The process 1500 may execute an optimization process at the first processing block based on the computing device topology and the operating graph to determine a parallelization solution for executing the operating graph with the computing device topology (block 1506). The optimization process may be metaheuristic such as a Markov Chain Monte Carlo simulation. The optimization process may also be dynamic programming, branch and bound, etc. In some aspects, executing the operating graph comprises training a neural network. In other aspects, executing the operating graph comprises inferring with a neural network.

The process 1500 may receive the parallelization solution at a second processing block (block 1508). The process 1500 may compute, at the second processing block, a bottleneck structure (block 1510). The process 1500 may compute, at the second processing block, a cost value of the parallelization solution based on the bottleneck structure (block 1512). The process 1500 may transmit the cost value from the second processing block to the first processing block (block 1514). The process 1500 may execute the optimization process at the first processing block based on the computing device topology, the operating graph, the cost value, to determine a neighbor parallelization solution (block 1516).

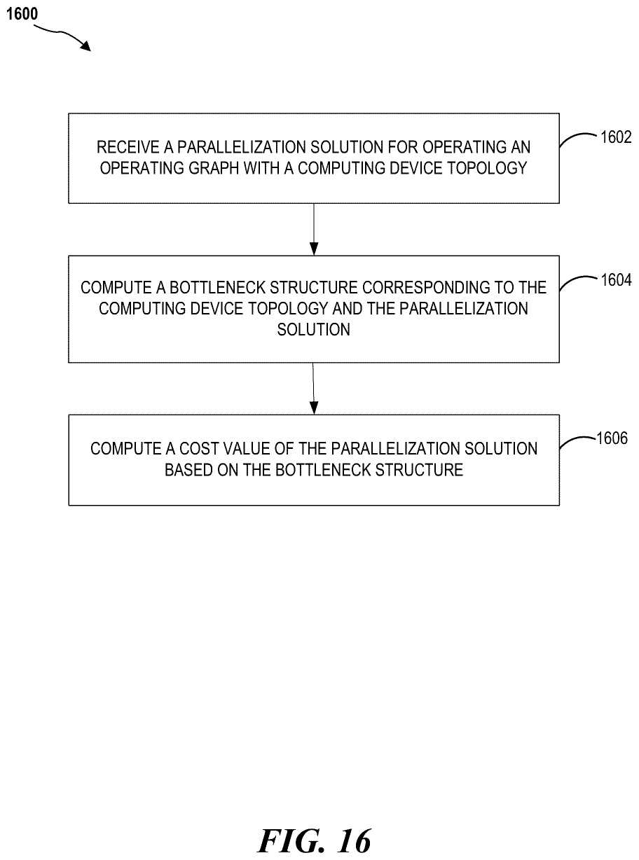

FIG. 16 illustrates a process 1600 for parallelizing an operator graph, in accordance with various aspects of the present disclosure. As shown in FIG. 16, the process 1600 may receive a parallelization solution for executing an operating graph with a computing device topology (block 1602). In some aspects, executing the operating graph comprises training a neural network. In other aspects, executing the operating graph comprises inferring with a neural network. The process 1600 may compute a bottleneck structure corresponding to the computing device topology and the parallelization solution (block 1604). The computing device topology may include a non-fully connected topology. The process 1600 may compute a cost value of the parallelization solution based on the bottleneck structure (block 1606).

### Example Aspects

Aspect 1: An apparatus, comprising: at least one memory; and at least one processor coupled to the at least one memory, the at least one processor configured to: receive an operator graph at a first processing block; receive a computing device topology at the first processing block; execute an optimization process at the first processing block based on the computing device topology and the operating graph to determine a parallelization solution for executing the operating graph with the computing device topology; receive the parallelization solution at a second processing block; compute, at the second processing block, a bottleneck structure; compute, at the second processing block, a cost value of the parallelization solution based on the bottleneck structure; transmit the cost value from the second processing block to the first processing block; and execute the optimization process at the first processing block based on the computing device topology, the operating graph, the cost value, to determine a neighbor parallelization solution.

Aspect 2: The apparatus of Aspect 1, in which the optimization process comprises a metaheuristic including a Markov Chain Monte Carlo simulation.

Aspect 3: The apparatus of Aspect 1 or 2, in which the computing device topology comprises at least one of a multicore processor, a system-on-chip, or a network of computing devices.

Aspect 4: The apparatus of any of the preceding Aspects, in which the at least one processor is further configured to execute the operating graph by training a neural network.

Aspect 5: The apparatus of any of the preceding Aspects, in which the at least one processor is further configured to execute the operating graph by inferring with a neural network.

Aspect 6: The apparatus of any of the preceding Aspects, in which the at least one processor is further configured to: calculate, at the first processing block, gradient information with the bottleneck structure corresponding to the computing device topology and the parallelization solution; and bias selection of the neighbor parallelization solution, at the first processing block, based on the gradient information.

Aspect 7: An apparatus comprising: at least one memory; and at least one processor coupled to the at least one memory, the at least one processor configured to: receive a parallelization solution for executing an operating graph with a computing device topology; compute a bottleneck structure corresponding to the computing device topology and the parallelization solution; and compute a cost value of the parallelization solution based on the bottleneck structure.

Aspect 8: The apparatus of Aspect 7, in which the computing device topology includes a non-fully connected topology.

Aspect 9: The apparatus of Aspect 7 or 8, in which the at least one processor is further configured to execute the operating graph comprises training a neural network.

Aspect 10: The apparatus of claim 7 or 8, in which the at least one processor is further configured to execute the operating graph comprises inferring with a neural network.

Aspect 11: A processor implemented method, comprising: receiving a parallelization solution for executing an operating graph with a computing device topology; computing a bottleneck structure corresponding to the computing device topology and the parallelization solution; and computing a cost value of the parallelization solution based on the bottleneck structure.

Aspect 12: The processor-implemented method of Aspect 11, in which the computing device topology includes a non-fully connected topology.

Aspect 13: The processor-implemented method of Aspect 11 or 12, in which operating the operating graph comprises training a neural network.

Aspect 14: The processor-implemented method of Aspect 11 or 12, in which operating the operating graph comprises inferring with a neural network.

Aspect 15: A processor-implemented method, comprising: receiving an operator graph at a first processing block; receiving a computing device topology at the first processing block; executing an optimization process at the first processing block based on the computing device topology and the operating graph to determine a parallelization solution for executing the operating graph with the computing device topology; receiving the parallelization solution at a second processing block; computing, at the second processing block, a bottleneck structure; computing, at the second processing block, a cost value of the parallelization solution based on the bottleneck structure; transmitting the cost value from the second processing block to the first processing block; and executing the optimization process at the first processing block based on the computing device topology, the operating graph, the cost value, to determine a neighbor parallelization solution.

Aspect 16: The processor-implemented method of Aspect 15, in which the optimization process comprises a metaheuristic including a Markov Chain Monte Carlo simulation.

Aspect 17: The processor-implemented method of Aspect 15 or 16, in which the computing device topology comprises at least one of a multicore processor, a system-on-chip, or a network of computing devices.

Aspect 18: The processor-implemented method of any of the Aspects 15-17, in which executing the operating graph comprises training a neural network.

Aspect 19: The processor-implemented method of any of the Aspects 15-17, in which executing the operating graph comprises inferring with a neural network.

Aspect 20: The processor-implemented method of any of the Aspects 15-19, further comprising: calculating, at the first processing block, gradient information with the bottleneck structure corresponding to the computing device topology and the parallelization solution; and biasing selection of the neighbor parallelization solution, at the first processing block, based on the gradient information.

It is clear that there are many ways to configure the device and/or system components, interfaces, communication links, and methods described. The disclosed methods, devices, and systems can be deployed on convenient processor platforms, including network servers, personal and portable computers, and/or other processing platforms. Other platforms can be contemplated as processing capabilities improve. including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted. Sets and subsets, in general, include one or more members.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communication protocols to facilitate communication between the different processors/processing elements. The processors can be configured for distributed processing and can utilize, in some aspects, a client-server model as needed. Accordingly, the methods, devices, and systems can utilize multiple processors and/or processor devices, and the processor/ processing element instructions can be divided amongst such single or multiple processor/devices/processing elements.

The device(s) or computer systems that integrate with the processor(s)/processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communication with other processors, where such one or more processor can be configured to operate on one or more processor/ processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communication protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific aspects thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the aspects disclosed herein, can include practices otherwise than specifically described, and are to be interpreted as broadly as allowed under the law.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing. and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed:

1. An apparatus, comprising:
at least one memory; and
at least one processor coupled to the at least one memory, the at least one processor configured to:
receive an operator graph at a first processing block;
receive a computing device topology at the first processing block;
execute an optimization process at the first processing block based on the computing device topology and the operating graph to determine a parallelization solution for executing the operating graph with the computing device topology;
receive the parallelization solution at a second processing block;
compute, at the second processing block, a bottleneck structure;
compute, at the second processing block, a cost value of the parallelization solution based on the bottleneck structure;
transmit the cost value from the second processing block to the first processing block; and
execute the optimization process at the first processing block based on the computing device topology, the operating graph, the cost value, to determine a neighbor parallelization solution.

2. The apparatus of claim 1, in which the optimization process comprises a metaheuristic including a Markov Chain Monte Carlo simulation.

3. The apparatus of claim 1, in which the computing device topology comprises at least one of a multicore processor, a system-on-chip, or a network of computing devices.

4. The apparatus of claim 1, in which the at least one processor is further configured to execute the operating graph by training a neural network.

5. The apparatus of claim 1, in which the at least one processor is further configured to execute the operating graph by inferring with a neural network.

6. The apparatus of claim 1, in which the at least one processor is further configured to:
calculate, at the first processing block, gradient information with the bottleneck structure corresponding to the computing device topology and the parallelization solution; and
bias selection of the neighbor parallelization solution, at the first processing block, based on the gradient information.

7. An apparatus comprising:
at least one memory; and
at least one processor coupled to the at least one memory, the at least one processor configured to:
receive a parallelization solution for executing an operating graph with a computing device topology;
compute a bottleneck structure corresponding to the computing device topology and the parallelization solution; and
compute a cost value of the parallelization solution based on the bottleneck structure.

8. The apparatus of claim 7, in which the computing device topology includes a non-fully connected topology.

9. The apparatus of claim 7, in which the at least one processor is further configured to execute the operating graph comprises training a neural network.

10. The apparatus of claim 7, in which the at least one processor is further configured to execute the operating graph comprises inferring with a neural network.

11. A processor implemented method, comprising:
receiving a parallelization solution for executing an operating graph with a computing device topology;
computing a bottleneck structure corresponding to the computing device topology and the parallelization solution; and
computing a cost value of the parallelization solution based on the bottleneck structure.

12. The processor-implemented method of claim 11, in which the computing device topology includes a non-fully connected topology.

13. The processor-implemented method of claim 11, in which operating the operating graph comprises training a neural network.

14. The processor-implemented method of claim 11, in which operating the operating graph comprises inferring with a neural network.

15. A processor-implemented method, comprising:
receiving an operator graph at a first processing block;
receiving a computing device topology at the first processing block;
executing an optimization process at the first processing block based on the computing device topology and the operating graph to determine a parallelization solution for executing the operating graph with the computing device topology;
receiving the parallelization solution at a second processing block;
computing, at the second processing block, a bottleneck structure;
computing, at the second processing block, a cost value of the parallelization solution based on the bottleneck structure;
transmitting the cost value from the second processing block to the first processing block; and
executing the optimization process at the first processing block based on the computing device topology, the operating graph, the cost value, to determine a neighbor parallelization solution.

16. The processor-implemented method of claim 15, in which the optimization process comprises a metaheuristic including a Markov Chain Monte Carlo simulation.

17. The processor-implemented method of claim 15, in which the computing device topology comprises at least one of a multicore processor, a system-on-chip, or a network of computing devices.

18. The processor-implemented method of claim 15, in which executing the operating graph comprises training a neural network.

19. The processor-implemented method of claim 15, in which executing the operating graph comprises inferring with a neural network.

20. The processor-implemented method of claim 15, further comprising:
calculating, at the first processing block, gradient information with the bottleneck structure corresponding to the computing device topology and the parallelization solution; and
biasing selection of the neighbor parallelization solution, at the first processing block, based on the gradient information.
